(19) United States
(12) Patent Application Publication
(10) Pub. No.: US 2026/0058785 A1
(43) Pub. Date: Feb. 26, 2026

(54) SUB-BAND FULL DUPLEX CONFIGURATION IN CARRIER AGGREGATION

(71) Applicant: QUALCOMM Incorporated, San Diego, CA (US)

(72) Inventors: Jae Ho RYU, San Diego, CA (US); Muhammad Sayed Khairy ABDELGHAFFAR, San Jose, CA (US); Heechoon LEE, San Diego, CA (US); Prashant SHARMA, San Marcos, CA (US)

(21) Appl. No.: 18/814,272

(22) Filed: Aug. 23, 2024

(51) Int. Cl. H04L 5/14; H04L 5/00

(52) U.S. Cl. CPC H04L 5/14; H04L 5/001; H04L 5/0037

(57) ABSTRACT

Aspects of sub-band full duplex (SBFD) configuration in carrier aggregation are described. In some examples, a network entity may output respective carrier aggregation configurations to a set of user equipments (UEs), and the respective carrier aggregation configurations may configure multiple component carriers for communication by the set of UEs. The network entity may output, to the set of UEs, respective SBFD configurations for SBFD operation across the multiple component carriers, and the respective SBFD configurations may include an SBFD pattern for the multiple component carriers. The SBFD pattern may include no more than one uplink sub-band across the multiple component carriers. The network entity may communicate one or more messages with the set of UEs in accordance with the respective SBFD configurations and the respective carrier aggregation configurations.

### FIELD OF TECHNOLOGY

The following relates to wireless communications, including sub-band full duplex configuration in carrier aggregation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a network entity is described. The method may include outputting respective carrier aggregation configurations to a set of user equipments (UEs), where the respective carrier aggregation configurations configure multiple component carriers (CCs) for communication by the set of UEs, outputting, to the set of UEs, respective sub-band full duplex (SBFD) configurations for SBFD operation across the multiple CCs, the respective SBFD configurations including an SBFD pattern for the multiple CCs, where the SBFD pattern includes no more than one uplink sub-band across the multiple CCs, and communicating one or more messages with the set of UEs in accordance with the respective SBFD configurations and the respective carrier aggregation configurations.

A network entity for wireless communication is described. The network entity may include one or more memories storing processor executable code, and one or more processors coupled with the one or more memories. The one or more processors may individually or collectively be operable to execute the code to cause the network entity to output respective carrier aggregation configurations to a set of user equipments (UEs), where the respective carrier aggregation configurations configure multiple CCs for communication by the set of UEs, output, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs, and communicate one or more messages with the set of UEs in accordance with the respective SBFD configurations and the respective carrier aggregation configurations.

Another network entity for wireless communication is described. The network entity may include means for outputting respective carrier aggregation configurations to a set of user equipments (UEs), where the respective carrier aggregation configurations configure multiple CCs for communication by the set of UEs, means for outputting, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs, and means for communicating one or more messages with the set of UEs in accordance with the respective SBFD configurations and the respective carrier aggregation configurations.

A non-transitory computer-readable medium storing code for wireless communication is described. The code may include instructions executable by one or more processors to output respective carrier aggregation configurations to a set of user equipments (UEs), where the respective carrier aggregation configurations configure multiple CCs for communication by the set of UEs, output, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs, and communicate one or more messages with the set of UEs in accordance with the respective SBFD configurations and the respective carrier aggregation configurations.

In some examples of the method, network entities, and non-transitory computer-readable medium described herein, the no more than one uplink sub-band may be configured within a single CC of the multiple CCs.

In some examples of the method, network entities, and non-transitory computer-readable medium described herein, the no more than one uplink sub-band may be configured across more than one contiguous CCs of the multiple CCs.

In some examples of the method, network entities, and non-transitory computer-readable medium described herein, the no more than one uplink sub-band occupies an entire bandwidth of one of the multiple CCs.

In some examples of the method, network entities, and non-transitory computer-readable medium described herein, the SBFD pattern includes one or more downlink sub-bands configured across the multiple CCs.

In some examples of the method, network entities, and non-transitory computer-readable medium described herein, the SBFD pattern includes no more than two downlink sub-bands configured across the multiple CCs and the multiple CCs may be contiguous.

In some examples of the method, network entities, and non-transitory computer-readable medium described herein, the multiple CCs include a first quantity of non-contiguous frequency blocks, the SBFD pattern includes a second quantity of downlink sub-bands configured across the multiple CCs, and the second quantity may be one greater than the first quantity.

In some examples of the method, network entities, and non-transitory computer-readable medium described herein, the SBFD pattern includes a downlink sub-band that spans at least two CCs of the multiple CCs and the at least two CCs may be contiguous.

In some examples of the method, network entities, and non-transitory computer-readable medium described herein, the multiple CCs may be contiguous.

In some examples of the method, network entities, and non-transitory computer-readable medium described herein, at least two CCs of the multiple CCs may be non-contiguous with each other.

In some examples of the method, network entities, and non-transitory computer-readable medium described herein, the multiple CCs include a first subset of CCs and a second subset of CCs, the first subset of CCs may be associated with a first SFBD pattern and the second subset of CCs may be associated with a second SFBD pattern, the first SFBD pattern and the second SFBD pattern may have a non-aligned time configuration, and the non-aligned time configuration may be based on capabilities of the set of UEs.

A method for wireless communication by a user equipment (UE) is described. The method may include receiving a carrier aggregation configuration that supports a first CC associated with a primary cell and a second CC associated with a secondary cell, receiving a SBFD configuration, the SBFD configuration including an SBFD pattern across the first CC and the second CC, receiving a configuration for a cross link interference measurement in a first CC, receiving an indication of a deactivation of the secondary cell, and determining whether to suspend the cross link interference measurement based on the SBFD pattern and the deactivation of the secondary cell.

A UE for wireless communication is described. The UE may include one or more memories storing processor executable code, and one or more processors coupled with the one or more memories. The one or more processors may individually or collectively be operable to execute the code to cause the UE to receive a carrier aggregation configuration that supports a first CC associated with a primary cell and a second CC associated with a secondary cell, receive a SBFD configuration, the SBFD configuration including an SBFD pattern across the first CC and the second CC, receive a configuration for a cross link interference measurement in a first CC, receive an indication of a deactivation of the secondary cell, and determine whether to suspend the cross link interference measurement based on the SBFD pattern and the deactivation of the secondary cell.

Another UE for wireless communication is described. The UE may include means for receiving a carrier aggregation configuration that supports a first CC associated with a primary cell and a second CC associated with a secondary cell, means for receiving a SBFD configuration, the SBFD configuration including an SBFD pattern across the first CC and the second CC, means for receiving a configuration for a cross link interference measurement in a first CC, means for receiving an indication of a deactivation of the secondary cell, and means for determining whether to suspend the cross link interference measurement based on the SBFD pattern and the deactivation of the secondary cell.

A non-transitory computer-readable medium storing code for wireless communication is described. The code may include instructions executable by one or more processors to receive a carrier aggregation configuration that supports a first CC associated with a primary cell and a second CC associated with a secondary cell, receive a SBFD configuration, the SBFD configuration including an SBFD pattern across the first CC and the second CC, receive a configuration for a cross link interference measurement in a first CC, receive an indication of a deactivation of the secondary cell, and determine whether to suspend the cross link interference measurement based on the SBFD pattern and the deactivation of the secondary cell.

In some examples of the method, UEs, and non-transitory computer-readable medium described herein, determining whether to suspend the cross link interference measurement may include operations, features, means, or instructions for determining to perform the cross link interference measurement based on the SBFD pattern including an uplink sub-band in the first CC for the cross link interference measurement.

Some examples of the method, UEs, and non-transitory computer-readable medium described herein may further include operations, features, means, or instructions for performing, subsequent to determining to perform the cross link interference measurement, the cross link interference measurement in the first CC.

In some examples of the method, UEs, and non-transitory computer-readable medium described herein, determining whether to suspend the cross link interference measurement may include operations, features, means, or instructions for determining to suspend the cross link interference measurement based on the SBFD pattern not including an uplink sub-band in the first CC for the cross link interference measurement.

A method for wireless communication by a UE is described. The method may include receiving a carrier aggregation configuration that supports a first CC and a second CC, receiving a SBFD pattern across the first CC and the second CC, and performing collision handling between a first grant in an uplink sub-band of the SBFD pattern and a second grant in a downlink sub-band of the SBFD pattern, where the uplink sub-band and the downlink sub-band are configured in one or more symbols.

A UE for wireless communication is described. The UE may include one or more memories storing processor executable code, and one or more processors coupled with the one or more memories. The one or more processors may individually or collectively be operable to execute the code to cause the UE to receive a carrier aggregation configuration that supports a first CC and a second CC, receive a SBFD pattern across the first CC and the second CC, and perform collision handling between a first grant in an uplink sub-band of the SBFD pattern and a second grant in a downlink sub-band of the SBFD pattern, where the uplink sub-band and the downlink sub-band are configured in one or more symbols.

Another UE for wireless communication is described. The UE may include means for receiving a carrier aggregation configuration that supports a first CC and a second CC, means for receiving a SBFD pattern across the first CC and the second CC, and means for performing collision handling between a first grant in an uplink sub-band of the SBFD pattern and a second grant in a downlink sub-band of the SBFD pattern, where the uplink sub-band and the downlink sub-band are configured in one or more symbols.

A non-transitory computer-readable medium storing code for wireless communication is described. The code may include instructions executable by one or more processors to receive a carrier aggregation configuration that supports a first CC and a second CC, receive a SBFD pattern across the first CC and the second CC, and perform collision handling between a first grant in an uplink sub-band of the SBFD pattern and a second grant in a downlink sub-band of the SBFD pattern, where the uplink sub-band and the downlink sub-band are configured in one or more symbols.

In some examples of the method, UEs, and non-transitory computer-readable medium described herein, uplink sub-band and the downlink sub-band may be in the first CC.

In some examples of the method, UEs, and non-transitory computer-readable medium described herein, uplink sub-band may be in the first CC and the downlink sub-band may be in the second CC.

In some examples of the method, UEs, and non-transitory computer-readable medium described herein, performing collision handling may include operations, features, means, or instructions for prioritizing dynamic scheduling in the uplink sub-band or the downlink sub-band over semi-static scheduling in the uplink sub-band or the downlink sub-band.

In some examples of the method, UEs, and non-transitory computer-readable medium described herein, performing collision handling may include operations, features, means, or instructions for prioritizing the uplink sub-band.

In some examples of the method, UEs, and non-transitory computer-readable medium described herein, performing collision handling may include operations, features, means, or instructions for prioritizing the downlink sub-band.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports sub-band full duplex (SBFD) configuration in carrier aggregation in accordance with one or more aspects of the present disclosure.

FIG. 2 shows an example of a wireless communications system that supports SBFD configuration in carrier aggregation in accordance with one or more aspects of the present disclosure.

FIG. 3 shows example resource diagrams that support SBFD configuration in carrier aggregation in accordance with one or more aspects of the present disclosure.

FIG. 4 shows example resource diagrams that support SBFD configuration in carrier aggregation in accordance with one or more aspects of the present disclosure.

FIG. 5 shows example resource diagrams that support SBFD configuration in carrier aggregation in accordance with one or more aspects of the present disclosure.

FIG. 6 shows an example of a process flow that supports SBFD configuration in carrier aggregation in accordance with one or more aspects of the present disclosure.

FIG. 7 shows example resource diagrams that support SBFD configuration in carrier aggregation in accordance with one or more aspects of the present disclosure.

FIG. 8 shows an example of a process flow that supports SBFD configuration in carrier aggregation in accordance with one or more aspects of the present disclosure.

FIG. 9 shows an example of a process flow that supports SBFD configuration in carrier aggregation in accordance with one or more aspects of the present disclosure.

FIGS. 10 and 11 show block diagrams of devices that support SBFD configuration in carrier aggregation in accordance with one or more aspects of the present disclosure.

FIG. 12 shows a block diagram of a communications manager that supports SBFD configuration in carrier aggregation in accordance with one or more aspects of the present disclosure.

FIG. 13 shows a diagram of a system including a device that supports SBFD configuration in carrier aggregation in accordance with one or more aspects of the present disclosure.

FIGS. 14 and 15 show block diagrams of devices that support SBFD configuration in carrier aggregation in accordance with one or more aspects of the present disclosure.

FIG. 16 shows a block diagram of a communications manager that supports SBFD configuration in carrier aggregation in accordance with one or more aspects of the present disclosure.

FIG. 17 shows a diagram of a system including a device that supports SBFD configuration in carrier aggregation in accordance with one or more aspects of the present disclosure.

FIGS. 18 through 20 show flowcharts illustrating methods that support SBFD configuration in carrier aggregation in accordance with one or more aspects of the present disclosure.

### DETAILED DESCRIPTION

In some wireless communications systems, a user equipment (UE) may be configured to support sub-band full duplex (SBFD) communications between the UE and a network entity or other wireless devices. In such cases, the network entity may configure one or more SBFD slots of a component carrier (CC) with both uplink resources (e.g., one or more uplink sub-bands) and downlink resources (e.g., one or more downlink sub-bands), and may communicate with a first UE via the uplink resources and communicate with a second UE via the downlink resources. In some cases, the UE may be configured to support carrier aggregation, and the UE may communicate with the network entity via more than one CC. Currently, wireless communications between the UE and the network entity may not support SBFD configuration in carrier aggregation.

Techniques for SBFD configuration in carrier aggregation are described herein. A group of CCs may be configured for joint SBFD operation. The CCs may be contiguous or non-contiguous. The group of CCs may each have the same time division duplexing (TDD) pattern for SBFD operation. The SBFD frequency configuration for downlink sub-bands and uplink sub-bands may be configured across the group of CCs with joint SBFD operation. In some examples, no more than one uplink sub-band may be configured across the group of CCs. In some examples, one or more downlink sub-bands may be configured across the group of CCs. The network entity may output respective carrier aggregation configurations to a set of UEs, and the respective carrier aggregation configurations may configure multiple CCs for communication by the set of UEs. The network entity may output, to the set of UEs, respective SBFD configurations for SBFD operation across the multiple CCs, and the respective SBFD configurations may include an SBFD pattern for the multiple CCs (e.g., in accordance with the joint SBFD operation). In some examples, the SBFD pattern may include no more than one uplink sub-band across the multiple CCs. The network entity may communicate messages with the set of UEs in accordance with the respective SBFD configurations and the respective carrier aggregation configurations.

In some cases, if a primary cell is associated with one of the CCs in the group of CCs with joint SBFD operation, and a secondary cell is associated with another CC of the group of CCs with SBFD operation, a downlink sub-band may be configured in the primary cell so the SBFD operation may be maintained when the secondary cell is deactivated. In some examples, the UE may receive a carrier aggregation configuration that supports a first CC associated with a primary cell and a second CC associated with a secondary cell. The UE may receive a SBFD configuration, and the SBFD configuration may include an SBFD pattern across the first CC and the second CC. The UE may receive a configuration for a cross link interference measurement in the first CC. The UE may receive an indication of a deactivation of the secondary cell, and the UE may determine whether to suspend the cross link interference measurement based at least in part on the SBFD pattern and the deactivation of the secondary cell.

In some cases, the UE may receive a carrier aggregation configuration that supports a first CC and a second CC. The UE may receive an SBFD pattern across the first CC and the second CC. The UE may perform collision handling between a first grant in an uplink sub-band of the SBFD pattern and a second grant in a downlink sub-band of the SBFD pattern, where the uplink sub-band and the downlink sub-band are configured in one or more symbols. In some examples, the UE may prioritize dynamic scheduling in the uplink sub-band or the downlink sub-band over semi-static scheduling in the uplink sub-band or the downlink sub-band.

Aspects of the disclosure are initially described in the context of wireless communications systems. Aspects of the disclosure are then described with reference to resource diagrams and process flows. Aspects of the disclosure are further illustrated by and described with reference to apparatus diagrams, system diagrams, and flowcharts that relate to SBFD configuration in carrier aggregation.

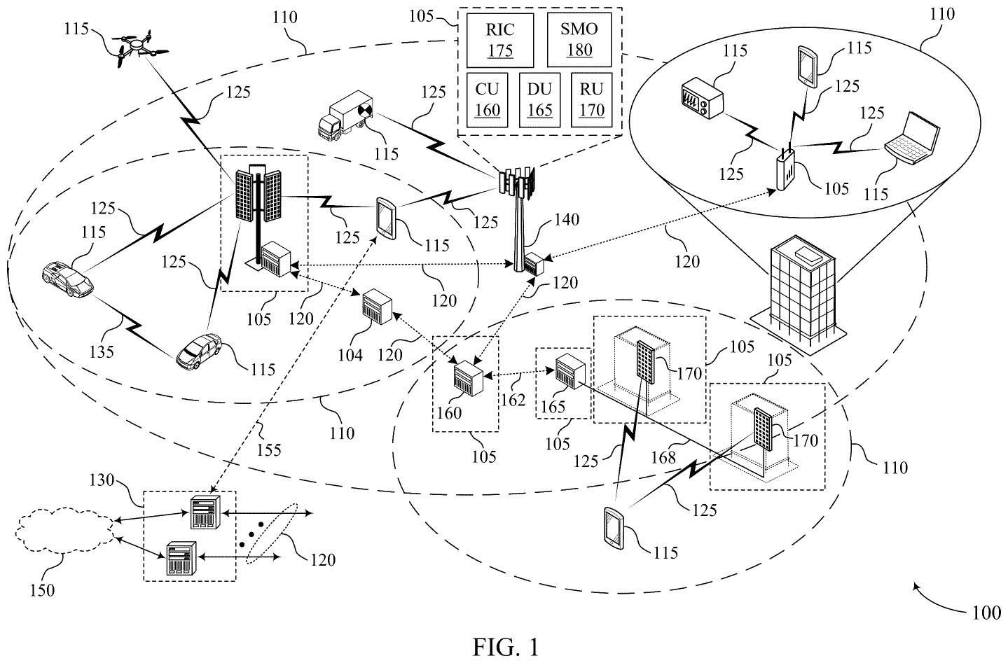

FIG. 1 shows an example of a wireless communications system 100 that supports SBFD configuration in carrier aggregation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Techniques for SBFD configuration in carrier aggregation may be employed. The network entity 105 may output respective carrier aggregation configurations to a set of UEs 115, and the respective carrier aggregation configurations may configure multiple CCs for communication by the set of UEs 115. The network entity 105 may output, to the set of UEs 115, respective SBFD configurations for SBFD operation across the multiple CCs, and the respective SBFD configurations may include an SBFD pattern for the multiple CCs. In some examples, the SBFD pattern may include no more than one uplink sub-band across the multiple CCs. The network entity 105 may communicate messages with the set of UEs 115 in accordance with the respective SBFD configurations and the respective carrier aggregation configurations.

In some cases, if a primary cell is associated with one of the CCs in the group of CCs with joint SBFD operation, and a secondary cell is associated with another CC of the group of CCs with SBFD operation, a downlink sub-band may be configured in the primary cell so the SBFD operation may be maintained when the secondary cell is deactivated. In some examples, the UE 115 may receive a carrier aggregation configuration that supports a first CC associated with a primary cell and a second CC associated with a secondary cell. The UE 115 may receive a SBFD configuration, and the SBFD configuration may include an SBFD pattern across the first CC and the second CC. The UE 115 may receive a configuration for a cross link interference measurement in the first CC. The UE 115 may receive an indication of a deactivation of the secondary cell, and the UE 115 may determine whether to suspend the cross link interference measurement based at least in part on the SBFD pattern and the deactivation of the secondary cell.

In some cases, the UE 115 may receive a carrier aggregation configuration that supports a first CC and a second CC. The UE 115 may receive an SBFD pattern across the first CC and the second CC. The UE 115 may perform collision handling between a first grant in an uplink sub-band of the SBFD pattern and a second grant in a downlink sub-band of the SBFD pattern, where the uplink sub-band and the downlink sub-band are configured in one or more symbols. In some examples, the UE 115 may prioritize dynamic scheduling in the uplink sub-band or the downlink sub-band over semi-static scheduling in the uplink sub-band or the downlink sub-band.

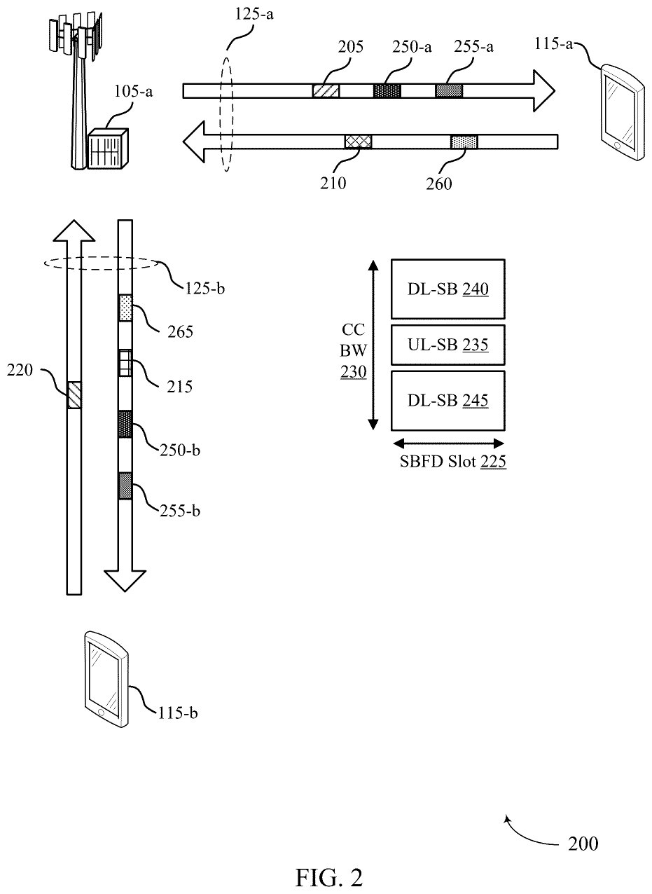

FIG. 2 shows an example of a wireless communications system 200 that supports SBFD configuration in carrier aggregation in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of a UE 115 as described herein. The wireless communications system 200 may also include a network entity 105-a, which may be an example of a network entity 105 as described herein.

The UE 115-a may communicate with the network entity 105-a using a communication link 125-a. The communication link 125-a may be an example of an NR or LTE link between the UE 115-a and the network entity 105-a. The communication link 125-a may include bi-directional links that enable both uplink and downlink communications. For example, the network entity 105-a may transmit downlink signals 205 (e.g., downlink transmissions), such as downlink control signaling and downlink data signals, to the UE 115-a using the communication link 125-a, and the UE 115-a may transmit uplink signals 210 (e.g., uplink transmissions), such as uplink control signaling and uplink data signals, to the network entity 105-a using the communication link 125-a.

The UE 115-b may communicate with the network entity 105-a using a communication link 125-b. The communication link 125-b may be an example of an NR or LTE link between the UE 115-b and the network entity 105-a. The communication link 125-b may include bi-directional links that enable both uplink and downlink communications. For example, the network entity 105-a may transmit downlink signals 215 (e.g., downlink transmissions), such as downlink control signaling and downlink data signals, to the UE 115-b using the communication link 125-b, and the UE 115-b may transmit uplink signals 220 (e.g., uplink transmissions), such as uplink control signaling and uplink data signals, to the network entity 105-a using the communication link 125-b.

In some cases, the wireless communications system 200 may support communication using SBFD operation. The UE 115-a and UE 115-b may be configured to support SBFD operations with the network entity 105-a. In such cases, the network entity 105-a may configure one or more SBFD slots (e.g., SBFD slot 225) of a CC 230 with both uplink resources (e.g., uplink sub-band 235) and downlink resources (e.g., downlink sub-band 240 and downlink sub-band 245). The network entity 105-a may communicate with the UE 115-a via the uplink resources (e.g., uplink sub-band 235) and may communicate with the UE 115-b via the downlink resources (e.g., downlink sub-band 240 or downlink sub-band 245). SBFD operation in TDD CCs may provide uplink coverage gain and capacity gain. In SBFD operation, the network entity 105-a may simultaneously transmit downlink signals (e.g., downlink signal 205) and may receive uplink signals (e.g., uplink signal 220) on a sub-band basis at the network entity 105-a. The UE 115-a and UE 115-b may operate in half-duplex mode with either UE receiving or transmitting at a given time. In some cases, SBFD operation may reduce latency by allowing transmission of uplink channels or signals in the uplink sub-band of legacy downlink slots and reception of downlink channels or signals in the downlink sub-band of legacy uplink slots. In some examples, the SBFD operation may provide flexible or dynamic uplink or downlink resource adaptation according to uplink or downlink traffic.

In some cases, for SBFD aware UEs (e.g., UE 115-a and UE 115-b), collisions between downlink reception in downlink sub-band(s) and uplink transmission in uplink sub-band in a SBFD symbol may be addressed or alleviated with scheduling. One case of potential collision may be dynamically scheduled downlink reception versus semi-statically configured uplink transmission (e.g., dynamic physical downlink shared channel (PDSCH) or channel state information reference signal (CSI-RS) collides with dynamic physical uplink shared channel (PUSCH) or physical uplink control channel (PUCCH)). A second case of potential collision may be semi-statically configured downlink reception versus dynamically scheduled uplink transmission (e.g., physical downlink control channel (PDCCH) or semi-persistent scheduling of PDSCH collides with dynamic PUSCH or PUCCH). A third case of potential collision may be semi-statically configured downlink reception versus semi-statically configured uplink transmission. A fourth case of potential collision may be dynamically scheduled downlink reception versus dynamically scheduled uplink transmission. A fifth case of potential collision may be synchronization signal block (SSB) versus dynamically scheduled or configured uplink transmission (e.g., PUSCH, PUCCH, physical random access channel (PRACH), sounding reference signal). A sixth case of potential collision may be dynamic or semi-static downlink versus a valid random access channel occasion (RO). In addition to collision between uplink transmission and downlink reception in the same SBFD symbol(s), collisions between uplink transmission and downlink reception in different symbol(s) may occur due to lack of sufficient transition time between transmission and reception at the UE side.

The wireless communications system 100 may support communication with the UE 115-a and UE 115-b using carrier aggregation. The UE 115-a and UE 115-b may be configured with multiple CCs according to a carrier aggregation configuration. Carrier aggregation may be used with both frequency division duplexing (FDD) and TDD CCs. In some examples, a group of CCs in the same band may be configured for joint SBFD operation.

In some examples, the network entity 105-a may transmit a carrier aggregation configuration 250-a to the UE 115-a and a carrier aggregation configuration 250-b to the UE 115-b. The carrier aggregation configurations may configure multiple CCs for communication by the UE 115-a and UE 115-b. In some cases, the network entity 105-a may transmit, to the UE 115-a and UE 115-b, SBFD configurations (e.g., SBFD configuration 255-a and SBFD configuration 255-b) for SBFD operation across the multiple CCs of the carrier aggregation configuration. The SBFD configurations may include an SBFD pattern for the multiple CCs. The network entity 105-a may communicate messages (e.g., message 260 and message 265) with the UE 115-a and UE 115-b in accordance with the respective SBFD configurations and the respective carrier aggregation configurations.

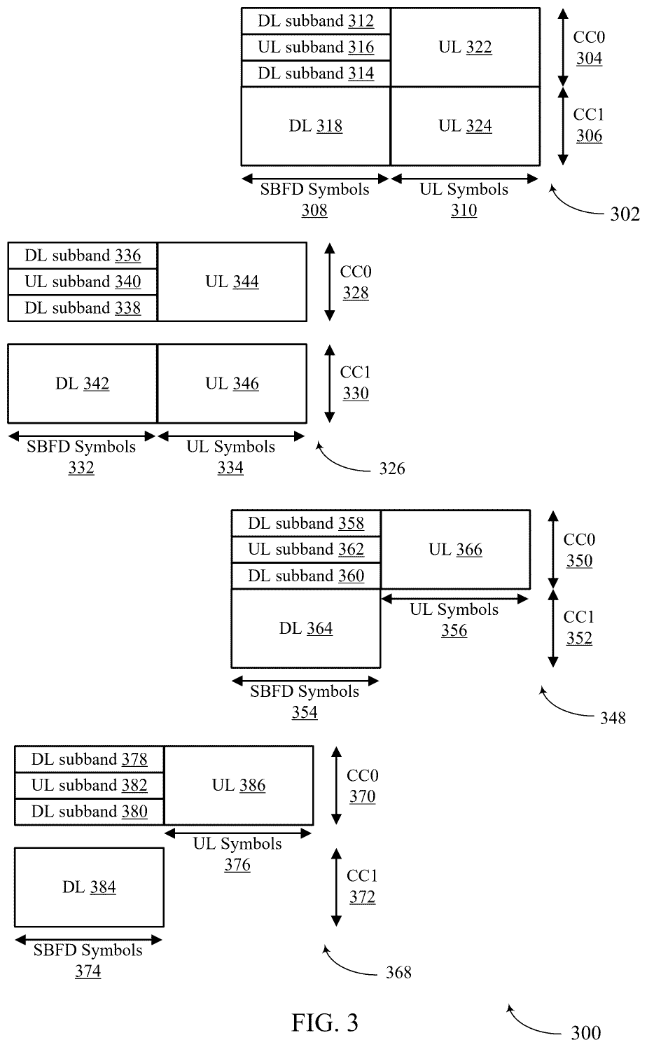

FIG. 3 shows example resource diagrams 300 that support SBFD configuration in carrier aggregation in accordance with one or more aspects of the present disclosure. The resource diagrams 300 may implement aspects of or may be implemented by aspects of the wireless communications system 100 and wireless communications system 200. The resource diagrams 300 illustrates an SBFD pattern 302, an SBFD pattern 326, an SBFD pattern 348, and an SBFD pattern 368 for joint SBFD operation across a group of CCs configured for carrier aggregation.

The resource diagrams 300 illustrate CC groups for joint SBFD operation. A group of CCs in the same band may be configured by the network entity 105-a for joint SBFD operation. In some cases, a group of CCs associated with joint SBFD operation may be intra-band contiguous CCs. In some cases, a group of CCs associated with joint SBFD operation may be intra-band contiguous CCs or intra-band non-contiguous CCs. Common cell-specific SBFD time configuration may be configured for the group of CCs associated with joint SBFD operation. In some cases, the group of CCs may have the same TDD pattern.

The SBFD pattern 302 illustrates a group of intra-band contiguous CCs (e.g., CC 304 and CC 306 are contiguous with each other). The SBFD pattern 302 includes SBFD symbols 308 and uplink symbols 310 across the CC 304 and the CC 306. The SBFD symbols 308 include downlink sub-bands (e.g., downlink sub-band 312 and downlink sub-band 314) and an uplink sub-band 316 in the CC 304, and the SBFD symbols 308 includes downlink sub-band 318 in the CC 306. The uplink symbols 310 include an uplink sub-band 322 in the CC 304 and an uplink sub-band 324 in the CC 306.

The SBFD pattern 326 illustrates a group of intra-band non-contiguous CCs (e.g., CC 328 and CC 330 are non-contiguous with each other). The SBFD pattern 326 includes SBFD symbols 332 and uplink symbols 334 across the CC 328 and the CC 330. The SBFD symbols 332 include downlink sub-bands (e.g., downlink sub-band 336 and downlink sub-band 338) and an uplink sub-band 340 in the CC 328, and the SBFD symbols 332 includes downlink sub-band 342 in the CC 330. The uplink symbols 334 include an uplink sub-band 344 in the CC 328 and an uplink sub-band 346 in the CC 330.

The SBFD pattern 348 illustrates a group of intra-band contiguous CCs (e.g., CC 350 and CC 352 are contiguous with each other). The SBFD pattern 348 includes SBFD symbols 354 and uplink symbols 356 across the CC 350 and the CC 352. The SBFD symbols 354 include downlink sub-bands (e.g., downlink sub-band 358 and downlink sub-band 360) and an uplink sub-band 362 in the CC 350, and the SBFD symbols 308 includes downlink sub-band 364 in the CC 352. The uplink symbols 356 include an uplink sub-band 366 in the CC 350 and do not include an uplink sub-band in the CC 352.

The SBFD pattern 368 illustrates a group of intra-band non-contiguous CCs (e.g., CC 370 and CC 372 are non-contiguous with each other). The SBFD pattern 368 includes SBFD symbols 374 and uplink symbols 376 across the CC 370 and the CC 372. The SBFD symbols 374 include downlink sub-bands (e.g., downlink sub-band 378 and downlink sub-band 380) and an uplink sub-band 382 in the CC 370, and the SBFD symbols 374 includes downlink sub-band 384 in the CC 372. The uplink symbols 376 include an uplink sub-band 386 in the CC 370 and do not include an uplink sub-band in the CC 372.

Two CC groups for joint SBFD operation in two different bands may have aligned SBFD configuration or may not have aligned SBFD configuration. If the UE (e.g., UE 115-a or UE 115-b) supports simultaneous transmission and reception in TDD-TDD inter-band carrier aggregation or TDD-TDD inter-band dual connectivity, the UE may be configured with aligned or non-aligned SBFD time configuration between two CC groups. If the UE does not support simultaneous transmission and reception in TDD-TDD inter-band carrier aggregation or TDD-TDD inter-band dual connectivity, the UE may be configured with aligned SBFD time configuration between two CC groups. For example, the multiple CCs may include a first subset of CCs and a second subset of CC, where the first subset of CCs is associated with a first SFBD pattern and the second subset of CCs is associated with a second SFBD pattern. The first SFBD pattern and the second SFBD pattern may have a non-aligned time configuration, and the non-aligned time configuration may be based on capabilities of the UEs (e.g., UE 115-a and UE 115-b). In some cases, the UE may indicate to the network entity 105-a a capability for simultaneous reception and transmission in TDD-TDD and TDD-FDD inter-band carrier aggregation. In some cases, the UE may include a field simultaneousRxTxInterBandCA in ca-ParametersNR-ForDC to indicate that the UE supports simultaneous transmission and reception between an uplink or downlink pair in the two different bands of TDD-TDD inter-band carrier aggregation or across a master cell group (MCG) and a secondary cell group (SCG) in TDD-TDD inter-band dual connectivity.

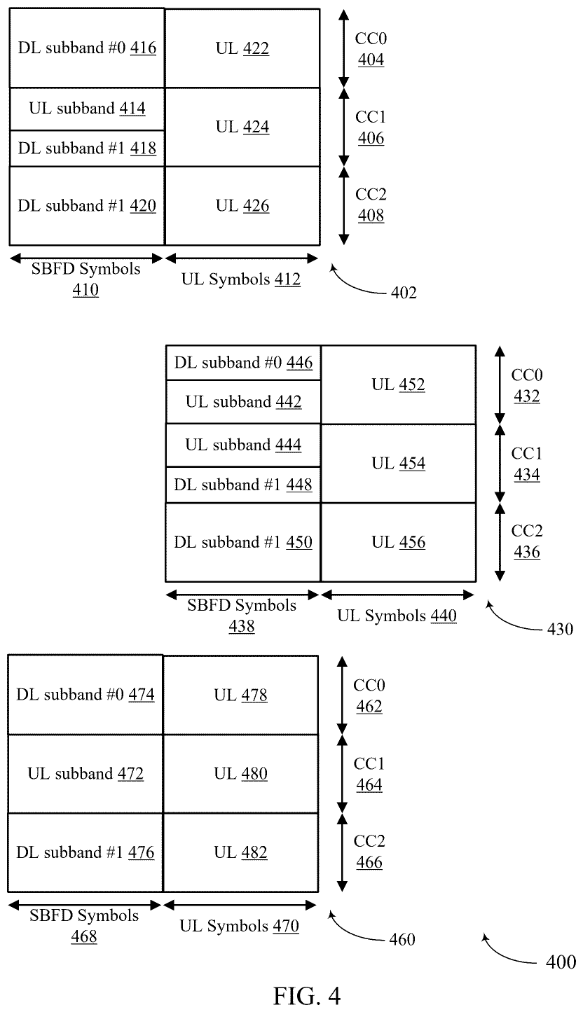

FIG. 4 shows example resource diagrams 400 that support SBFD configuration in carrier aggregation in accordance with one or more aspects of the present disclosure. The resource diagrams 400 may implement aspects of or may be implemented by aspects of the wireless communications system 100 and wireless communications system 200. The resource diagrams 400 illustrate SBFD frequency configuration for an SBFD pattern 402, an SBFD pattern 430, and an SBFD pattern 460 for joint SBFD operation across a group of CCs configured for carrier aggregation.

In some examples, the network entity 105-a may configure a cell-specific SBFD frequency configuration for downlink sub-bands and uplink sub-bands across a group of CCs associated with joint SBFD operation. In one examples, only one uplink sub-band (e.g., no more than one uplink sub-band) may be configured across a group of CCs. For example, the uplink sub-band may be configured within a single CC, or the uplink sub-band may be configured across multiple contiguous CCs. In some cases, the uplink sub-band may occupy the whole bandwidth of a CC.

The SBFD pattern 402 illustrates a group of CCs (e.g., CC 404, CC 406 and CC 406). The SBFD pattern 402 includes SBFD symbols 410 and uplink symbols 412 across the CC 404, the CC 406 and the CC 408. The SBFD symbols 410 include no more than one uplink sub-band 414 within a single CC (e.g., CC 406). The SBFD symbols 410 include a downlink sub-band #0 416 in the CC 404, a downlink sub-band #1 418 in the CC 406, and a downlink sub-band #1 420 in the CC 408. The uplink symbols 412 include an uplink sub-band 422 in the CC 404, and uplink sub-band 424 in the CC 406, and an uplink sub-band 426 in the CC 408.

The SBFD pattern 430 illustrates a group of CCs (e.g., CC 432, CC 434 and CC 436). The SBFD pattern 430 includes SBFD symbols 438 and uplink symbols 440 across the CC 432, the CC 434 and the CC 436. The SBFD symbols 438 include no more than one uplink sub-band configured across a group of CCs (e.g., across two CCs). For example, the no more than one uplink sub-band includes an uplink sub-band 442 in CC 432 and an uplink sub-band 444 in CC 434. The SBFD symbols 438 include a downlink sub-band #0 446 in the CC 432, a downlink sub-band #1 448 in the CC 434, and a downlink sub-band #1 450 in the CC 436. The uplink symbols 440 include an uplink sub-band 452 in the CC 432, and uplink sub-band 454 in the CC 434, and an uplink sub-band 456 in the CC 436.

The SBFD pattern 460 illustrates a group of CCs (e.g., CC 462, CC 464 and CC 466). The SBFD pattern 460 includes SBFD symbols 468 and uplink symbols 470 across the CC 462, the CC 464 and the CC 466. The SBFD symbols 468 include no more than one uplink sub-band configured to occupy a whole CC or entire bandwidth of the CC. For example, the no more than one uplink sub-band includes an uplink sub-band 472 in CC 464 that occupies the whole CC or entire bandwidth of the CC 464. The SBFD symbols 468 include a downlink sub-band #0 474 in the CC 462, and a downlink sub-band #1 476 in the CC 466. The uplink symbols 470 include an uplink sub-band 478 in the CC 462, and uplink sub-band 480 in the CC 464, and an uplink sub-band 482 in the CC 466.

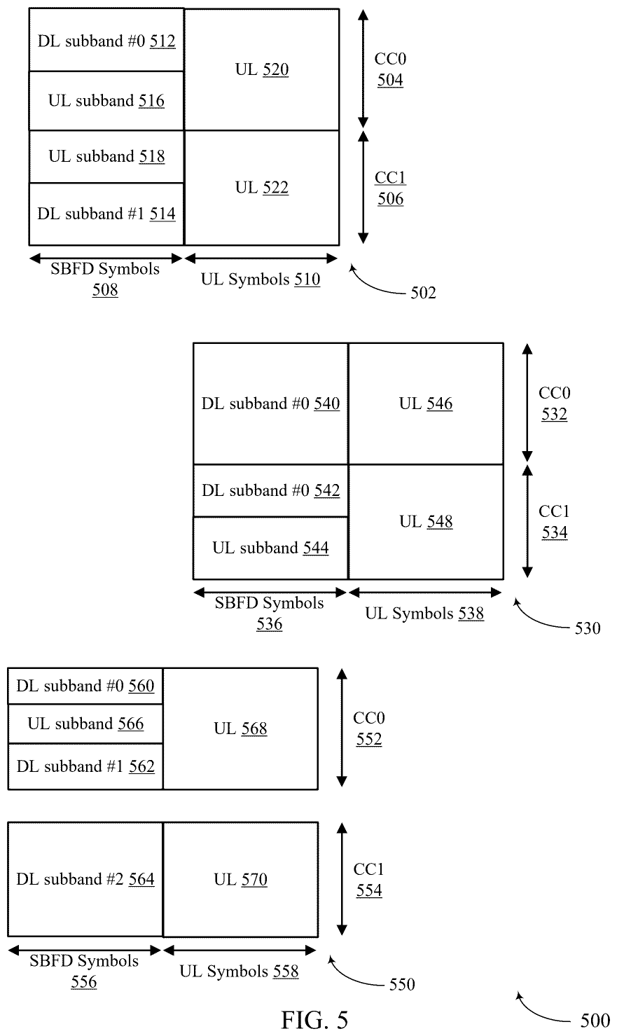

FIG. 5 shows example resource diagrams 500 that support SBFD configuration in carrier aggregation in accordance with one or more aspects of the present disclosure. The resource diagrams 500 may implement aspects of or may be implemented by aspects of the wireless communications system 100 and wireless communications system 200. The resource diagrams 500 illustrate SBFD frequency configuration for an SBFD pattern 502, an SBFD pattern 530, and an SBFD pattern 550 for joint SBFD operation across a group of CCs configured for carrier aggregation.

In some examples, the network entity 105-a may configure a cell-specific SBFD frequency configuration for downlink sub-bands and uplink sub-bands across a group of CCs associated with joint SBFD operation. In some examples, one or more downlink sub-bands may be configured across a group of CCs. For intra-band contiguous carrier aggregation, up to two downlink sub-bands may be configured. For intra-band non-contiguous carrier aggregation, up to N+1 downlink sub-bands may be configured where N is a quantity of frequency blocks in the intra-band non-contiguous carrier aggregation. In some cases, the downlink sub-band may span one or more contiguous CCs.

The SBFD pattern 502 illustrates a group of CCs (e.g., CC 504 and CC 506) with intra-band contiguous carrier aggregation. The SBFD pattern 502 includes SBFD symbols 508 and uplink symbols 510 across the CC 504 and the CC 506. The SBFD symbols 508 includes two downlink sub-bands configured across CC 504 and CC 506. The SBFD symbols 508 include a downlink sub-band #0 512 in the CC 504, and a downlink sub-band #1 514 in the CC 506. The SBFD symbols 508 include an uplink sub-band 516 in CC 504 and an uplink sub-band 518 in the CC 506. The uplink symbols 510 include an uplink sub-band 520 in the CC 504 and an uplink sub-band 522 in the CC 506.

The SBFD pattern 530 illustrates a group of CCs (e.g., CC 532 and CC 534) with intra-band contiguous carrier aggregation. The SBFD pattern 530 includes SBFD symbols 536 and uplink symbols 538 across the CC 532 and the CC 534. The SBFD symbols 536 include one downlink sub-band spanning the contiguous CCs (e.g., CC 532 and CC 534). For example, the downlink sub-band 540 in CC 532 and the downlink sub-band 542 in CC 534. The SBFD symbols 508 include an uplink sub-band 544 in CC 554. The uplink symbols 538 include an uplink sub-band 546 in the CC 532 and an uplink sub-band 548 in the CC 534.

The SBFD pattern 550 illustrates a group of CCs (e.g., CC 552 and CC 554) with intra-band non-contiguous carrier aggregation. The SBFD pattern 550 includes SBFD symbols 556 and uplink symbols 558 across the CC 552 and the CC 554. The SBFD symbols 556 include three downlink sub-bands spanning the non-contiguous CCs (e.g., CC 552 and CC 554). For example, the intra-band non-contiguous carrier aggregation includes two blocks (e.g., N=2), and the quantity of downlink sub-bands may be up to three (e.g., N+1). For example, the SBFD symbols include downlink sub-band 560 in CC 552, downlink sub-band 562 in CC 552, and downlink sub-band 564 in CC 554. The SBFD symbols 508 include an uplink sub-band 566 in CC 552. The uplink symbols 558 include an uplink sub-band 568 in the CC 552 and an uplink sub-band 570 in the CC 554.

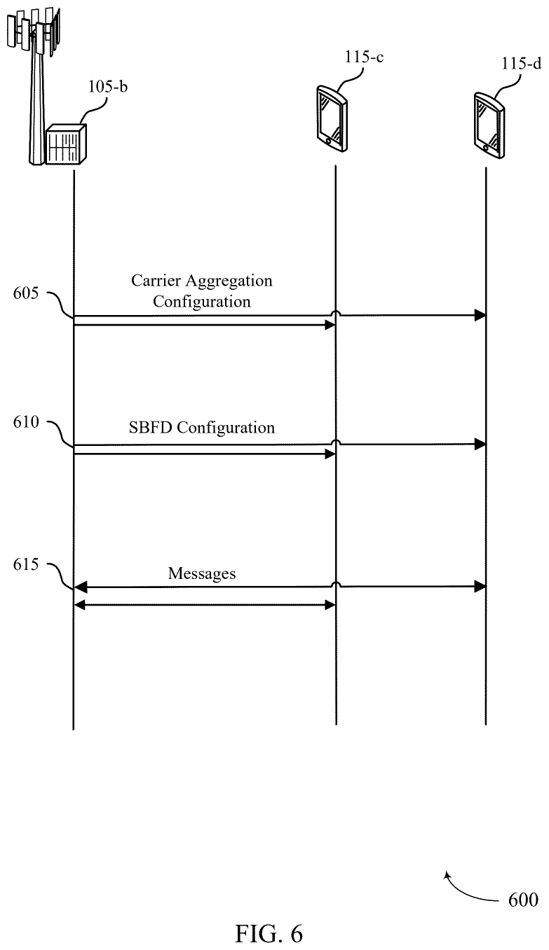

FIG. 6 shows an example of a process flow 600 that supports SBFD configuration in carrier aggregation in accordance with one or more aspects of the present disclosure. In some examples, the process flow 600 may implement or be implemented by aspects of the wireless communications systems 100 and 200 as described with reference to FIGS. 1 and 2, respectively. For example, the process flow 600 may be implemented by a UE 115-c and a UE 115-d, which may be examples of the UEs 115 as described with reference to FIGS. 1 and 2. The process flow 600 may be implemented by a network entity 105-b, which may be an example of the network entities 105 as described with reference to FIGS. 1 and 2.

In some examples, the operations illustrated in process flow 600 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 605, the network entity 105-b may output, to the UE 115-c and the UE 115-d, respective carrier aggregation configurations. The respective carrier aggregation configurations may configure multiple CCs for communication by the UE 115-c and the UE 115-d. In some examples, the multiple CCs may be contiguous. In some cases, at least two CCs of the multiple CCs are non-contiguous with each other.

At 610, the network entity 105-b may output, to the UE 115-c and the UE 115-d, respective SBFD configurations for SBFD operation across the multiple CCs. The respective SBFD configurations may include an SBFD pattern for the multiple CCs, where the SBFD pattern includes no more than one uplink sub-band across the multiple CCs. In some examples, the no more than one uplink sub-band may be configured within a single CC of the multiple CCs. In some cases, the no more than one uplink sub-band may be configured across more than one contiguous CC of the multiple CCs. In some examples, the no more than one uplink sub-band may occupy an entire bandwidth of one of the multiple CCs. In some cases, the SBFD pattern may include one or more downlink sub-bands configured across the multiple CCs. In some examples, the SBFD pattern may include no more than two downlink sub-bands configured across the multiple CCs, where the multiple CCs are contiguous. In some cases, the multiple CCs may include a first quantity of non-contiguous frequency blocks, and the SBFD pattern may include a second quantity of downlink sub-bands configured across the multiple CCs, where the second quantity is one greater than the first quantity. In some cases, the SBFD pattern may include a downlink sub-band that spans at least two CCs of the multiple CCs, where the at least two CCs are contiguous. In some examples, the multiple CCs may include a first subset of CCs and a second subset of CCs, and the first subset of CCs may be associated with a first SFBD pattern and the second subset of CCs may be associated with a second SFBD pattern. The first SFBD pattern and the second SFBD pattern may have a non-aligned time configuration, and the non-aligned time configuration may be based on capabilities of the UE 115-c and the UE 115-d.

At 615, the network entity may communicate, with the UE 115-c and the UE 115-d, one or more messages in accordance with the respective SBFD configurations and the respective carrier aggregation configurations.

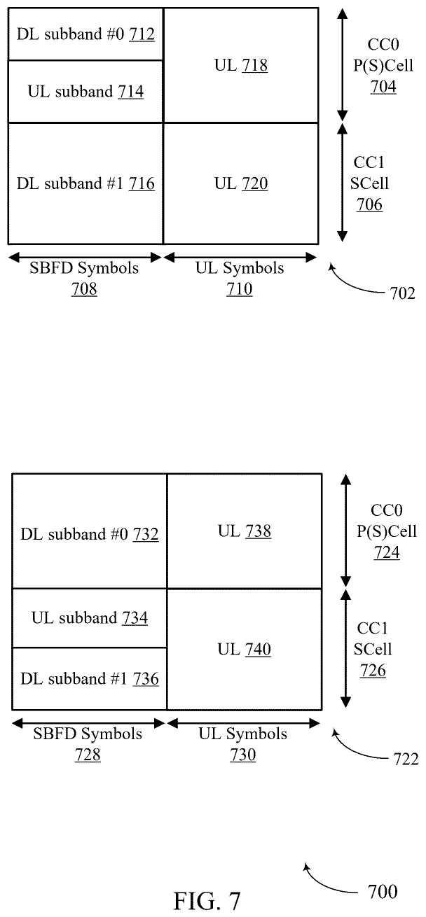

FIG. 7 shows example resource diagrams 700 that support SBFD configuration in carrier aggregation in accordance with one or more aspects of the present disclosure. The resource diagrams 700 may implement aspects of or may be implemented by aspects of the wireless communications system 100 and wireless communications system 200. The resource diagrams 700 illustrate SBFD configuration for a primary cell or primary serving cell (P(S)Cell) and a secondary (SCell) with joint SBFD operation in carrier aggregation. The resource diagrams 700 illustrates SBFD frequency configuration for an SBFD pattern 702 and an SBFD pattern 722 for joint SBFD operation across a group of CCs configured for carrier aggregation.

In some examples, if a P(S)Cell is one of the CCs in the group of CCs in the carrier aggregation, a downlink sub-band may be configured in the P(S)Cell. The uplink sub-band may be configured in the P(S)Cell or the uplink sub-band may not be configured in the P(S)Cell. If the P(S)Cell has both uplink sub-band and downlink sub-bands, the SBFD operation may be maintained when a SCell is deactivated. The downlink sub-band may be configured in the P(S)Cell to ensure that the P(S)Cell has a downlink sub-band available if the SCell is deactivated.

The SBFD pattern 702 illustrates an uplink sub-band and a downlink sub-band configured in the SBFD symbols for the CC associated with the P(S)Cell. The SBFD pattern 702 illustrates a group of CCs (e.g., CC 704 and CC 706) with intra-band contiguous carrier aggregation. The CC 704 is associated with a primary cell or P(S)Cell, and the CC 706 is associated with an SCell. The SBFD pattern 702 includes SBFD symbols 708 and uplink symbols 710 across the CC 704 and the CC 706. The SBFD symbols 708 includes a downlink sub-band 712 and an uplink sub-band 714 in the CC 704 associated with the P(S)Cell. The SBFD symbols 708 includes a downlink sub-band 716 in CC 706 associated with the SCell. The uplink symbols 710 include an uplink sub-band 718 in the CC 704 and an uplink sub-band 720 in the CC 706.

The SBFD pattern 722 illustrates a downlink sub-band configured in the SBFD symbols for the CC associated with the P(S)Cell and no uplink sub-band. The SBFD pattern 722 illustrates a group of CCs (e.g., CC 724 and CC 726) with intra-band contiguous carrier aggregation. The CC 724 is associated with a primary cell or P(S)Cell, and the CC 726 is associated with an SCell. The SBFD pattern 722 includes SBFD symbols 728 and uplink symbols 730 across the CC 724 and the CC 726. The SBFD symbols 728 includes a downlink sub-band 732 in the CC 724 associated with the P(S)Cell. The SBFD symbols 728 includes an uplink sub-band 734 and a downlink sub-band 736 in CC 726 associated with the SCell. The uplink symbols 730 include an uplink sub-band 738 in the CC 724 and an uplink sub-band 740 in the CC 726.

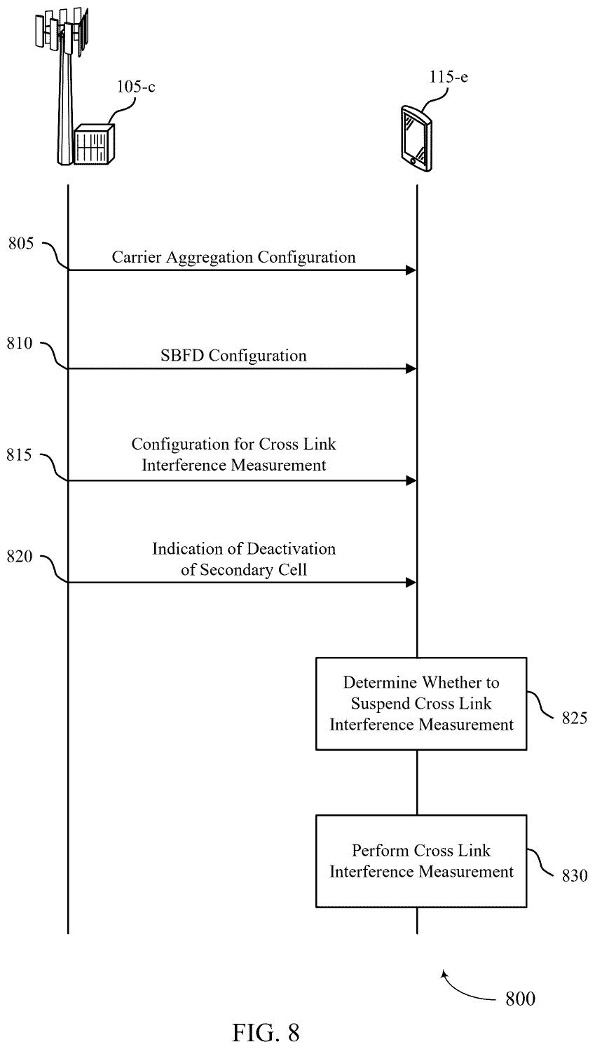

FIG. 8 shows an example of a process flow 800 that supports SBFD configuration in carrier aggregation in accordance with one or more aspects of the present disclosure. In some examples, the process flow 800 may implement or be implemented by aspects of the wireless communications systems 100 and 200 as described with reference to FIGS. 1 and 2, respectively. For example, the process flow 800 may be implemented by a UE 115-e, which may be examples of the UEs 115 as described with reference to FIGS. 1 and 2. The process flow 800 may be implemented by a network entity 105-c, which may be an example of the network entities 105 as described with reference to FIGS. 1 and 2. The process flow 800 illustrates a cross link interference measurement technique for a UE with SBFD operation in carrier aggregation.

In some examples, the operations illustrated in process flow 800 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 805, the UE 115-e may receive a carrier aggregation configuration that supports a first CC associated with a primary cell and a second CC associated with a secondary cell.

At 810, the UE 115-e may receive a SBFD configuration, and the SBFD configuration may include an SBFD pattern across the first CC and the second CC.

At 815, the UE 115-e may receive a configuration for a cross link interference measurement in the first CC. In some cases, the cross link interference measurement may be measured in either a downlink sub-band or an uplink sub-band.

At 820, the UE 115-e may receive an indication of a deactivation of the secondary cell.

At 825, the UE 115-e may determine whether to suspend the cross link interference measurement based at least in part on the SBFD pattern and the deactivation of the secondary cell. In some examples, the UE 115-e may determine to perform the cross link interference measurement based on the SBFD pattern including an uplink sub-band in the first CC for the cross link interference measurement. In some cases, the UE 115-e may determine to suspend the cross link interference measurement based on the SBFD pattern not including an uplink sub-band in the first CC for the cross link interference measurement.

At 830, the UE 115-e may perform the cross link interference measurement in the first CC where the cross link interference measurement is not suspended.

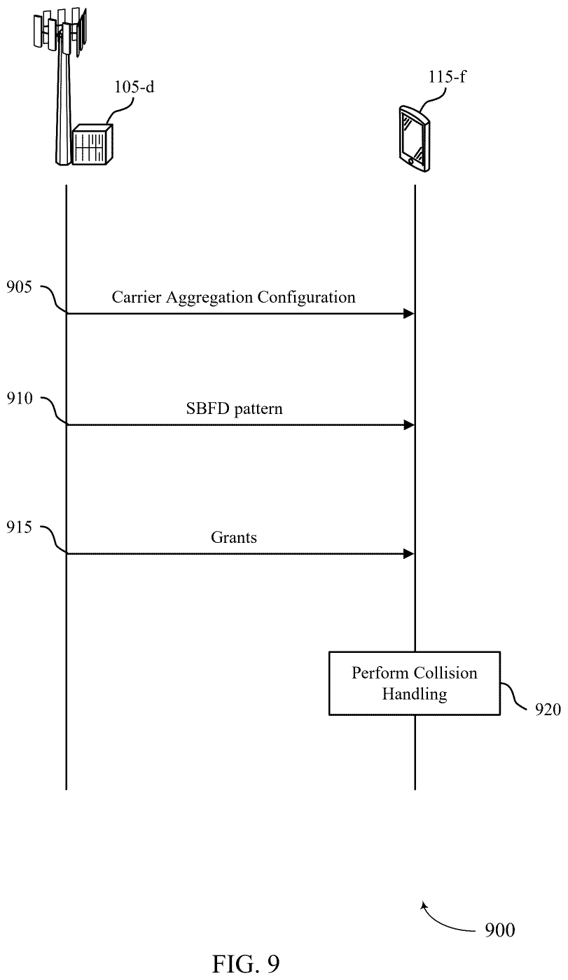

FIG. 9 shows an example of a process flow 900 that supports SBFD configuration in carrier aggregation in accordance with one or more aspects of the present disclosure. In some examples, the process flow 900 may implement or be implemented by aspects of the wireless communications systems 100 and 200 as described with reference to FIGS. 1 and 2, respectively. For example, the process flow 900 may be implemented by a UE 115-f, which may be examples of the UEs 115 as described with reference to FIGS. 1 and 2. The process flow 900 may be implemented by a network entity 105-d, which may be an example of the network entities 105 as described with reference to FIGS. 1 and 2. The process flow 900 illustrates a collision handling technique for a UE with SBFD operation in carrier aggregation.

In some examples, the operations illustrated in process flow 900 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

In some cases, joint SBFD operation for a group of cells or CCs in a band may be configured when multiple serving cells are configured in the same TDD band, and the cells in the same band may be associated with joint SBFD operation, where the network entity is not allowed to configure a cell without joint SBFD operation at least for downlink or uplink collision handling purpose. A cell may be configured without an uplink sub-band or downlink sub-band in the SBFD symbol. SBFD time and frequency configuration may not be changed when any of the cells in the band are activated or deactivated. The network entity 105-d may modify SBFD time and frequency configurations simultaneously for all cells within the band via RRC signaling.

The process flow 900 illustrates a collision handling technique for a UE with SBFD operation in carrier aggregation. At 905, the UE 115-f may receive a carrier aggregation configuration that supports a first CC and a second CC.

At 910, the UE 115-f may receive a SBFD pattern (e.g., via an SBFD configuration) across the first CC and the second CC.

At 915, the UE 115-f may receive a first grant in an uplink sub-band of the SBFD pattern and a second grant in a downlink sub-band of the SBFD pattern.

At 920, the UE 115-f may perform collision handling between the first grant in the uplink sub-band of the SBFD pattern and the second grant in the downlink sub-band of the SBFD pattern. The uplink sub-band and the downlink sub-band may be configured in one or more symbols. In some examples, the uplink sub-band and the downlink sub-band may be in the first CC. In some examples, the uplink sub-band is in the first CC and the downlink sub-band is in the second CC. In some examples, to perform the collision handling, the UE 115-f may prioritize dynamic scheduling in the uplink sub-band or the downlink sub-band over semi-static scheduling in the uplink sub-band or the downlink sub-band. In some cases, to perform the collision handling, the UE 115-f may prioritize the uplink sub-band or the downlink sub-band.

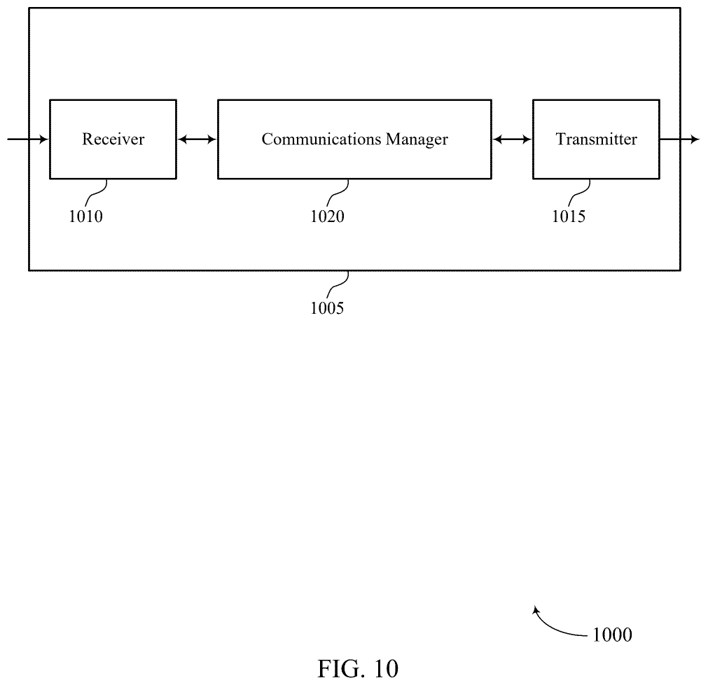

FIG. 10 shows a block diagram 1000 of a device 1005 that supports SBFD configuration in carrier aggregation in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of SBFD configuration in carrier aggregation as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for outputting respective carrier aggregation configurations to a set of UEs, where the respective carrier aggregation configurations configure multiple CCs for communication by the set of UEs. The communications manager 1020 is capable of, configured to, or operable to support a means for outputting, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs. The communications manager 1020 is capable of, configured to, or operable to support a means for communicating one or more messages with the set of UEs in accordance with the respective SBFD configurations and the respective carrier aggregation configurations.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

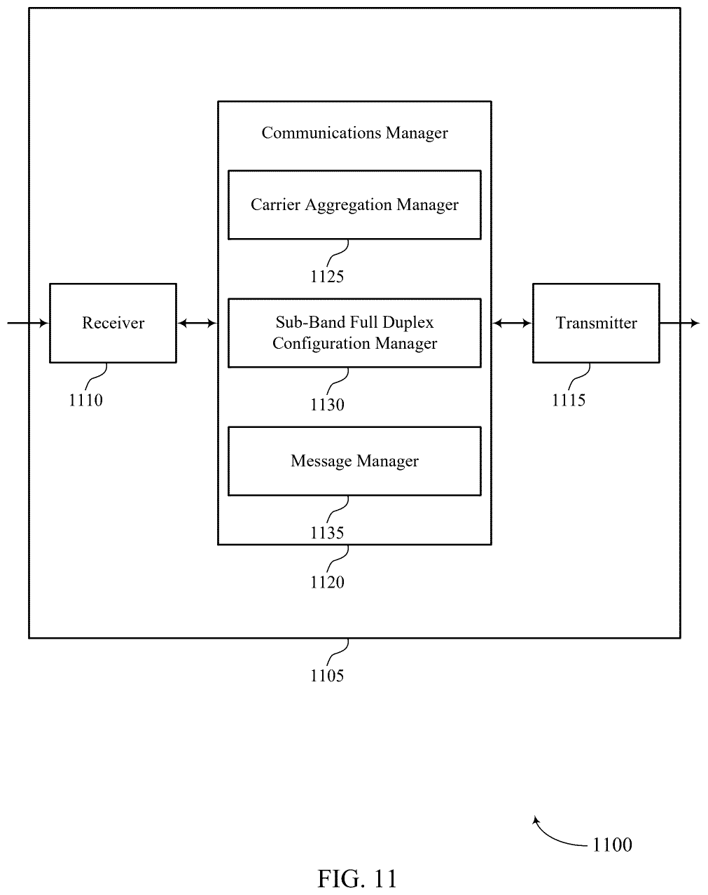

FIG. 11 shows a block diagram 1100 of a device 1105 that supports SBFD configuration in carrier aggregation in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of SBFD configuration in carrier aggregation as described herein. For example, the communications manager 1120 may include a carrier aggregation manager 1125, a SBFD configuration manager 1130, a message manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The carrier aggregation manager 1125 is capable of, configured to, or operable to support a means for outputting respective carrier aggregation configurations to a set of UEs, where the respective carrier aggregation configurations configure multiple CCs for communication by the set of UEs. The SBFD configuration manager 1130 is capable of, configured to, or operable to support a means for outputting, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs. The message manager 1135 is capable of, configured to, or operable to support a means for communicating one or more messages with the set of UEs in accordance with the respective SBFD configurations and the respective carrier aggregation configurations.

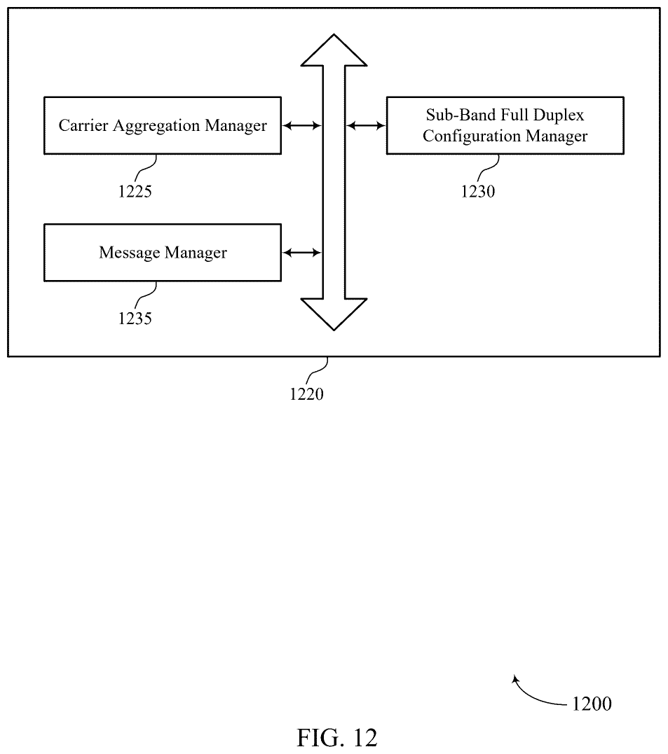

FIG. 12 shows a block diagram 1200 of a communications manager 1220 that supports SBFD configuration in carrier aggregation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of SBFD configuration in carrier aggregation as described herein. For example, the communications manager 1220 may include a carrier aggregation manager 1225, a SBFD configuration manager 1230, a message manager 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The carrier aggregation manager 1225 is capable of, configured to, or operable to support a means for outputting respective carrier aggregation configurations to a set of UEs, where the respective carrier aggregation configurations configure multiple CCs for communication by the set of UEs. The SBFD configuration manager 1230 is capable of, configured to, or operable to support a means for outputting, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs. The message manager 1235 is capable of, configured to, or operable to support a means for communicating one or more messages with the set of UEs in accordance with the respective SBFD configurations and the respective carrier aggregation configurations.

In some examples, the no more than one uplink sub-band is configured within a single CC of the multiple CCs.

In some examples, the no more than one uplink sub-band is configured across more than one contiguous CCs of the multiple CCs.

In some examples, the no more than one uplink sub-band occupies an entire bandwidth of one of the multiple CCs.

In some examples, the SBFD pattern includes one or more downlink sub-bands configured across the multiple CCs.

In some examples, the SBFD pattern includes no more than two downlink sub-bands configured across the multiple CCs. In some examples, the multiple CCs are contiguous.

In some examples, the multiple CCs include a first quantity of non-contiguous frequency blocks. In some examples, the SBFD pattern includes a second quantity of downlink sub-bands configured across the multiple CCs. In some examples, the second quantity is one greater than the first quantity.

In some examples, the SBFD pattern includes a downlink sub-band that spans at least two CCs of the multiple CCs. In some examples, the at least two CCs are contiguous.

In some examples, the multiple CCs are contiguous.

In some examples, at least two CCs of the multiple CCs are non-contiguous with each other.

In some examples, the multiple CCs include a first subset of CCs and a second subset of CCs. In some examples, the first subset of CCs is associated with a first SFBD pattern and the second subset of CCs is associated with a second SFBD pattern. In some examples, the first SFBD pattern and the second SFBD pattern have a non-aligned time configuration. In some examples, the non-aligned time configuration is based on capabilities of the set of UEs.

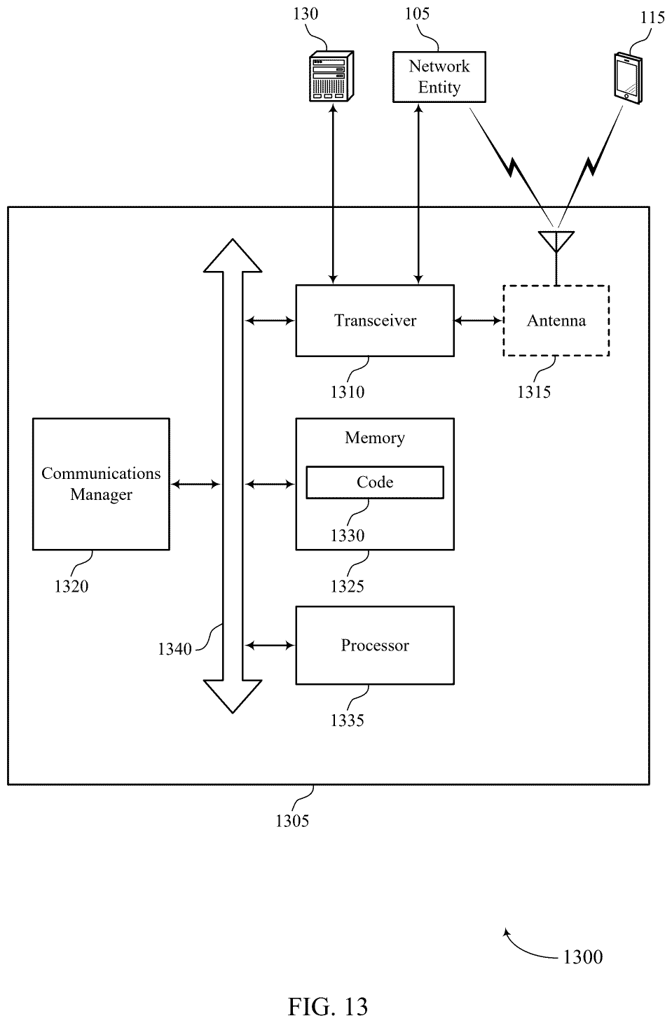

FIG. 13 shows a diagram of a system 1300 including a device 1305 that supports SBFD configuration in carrier aggregation in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting SBFD configuration in carrier aggregation). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for outputting respective carrier aggregation configurations to a set of UEs, where the respective carrier aggregation configurations configure multiple CCs for communication by the set of UEs. The communications manager 1320 is capable of, configured to, or operable to support a means for outputting, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs. The communications manager 1320 is capable of, configured to, or operable to support a means for communicating one or more messages with the set of UEs in accordance with the respective SBFD configurations and the respective carrier aggregation configurations.

By including or configuring the communications manager 1320 in accordance with examples as described herein, the device 1305 may support techniques for reduced latency, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of SBFD configuration in carrier aggregation as described herein, or the at least one processor 1335 and the at least one memory 1325 may be otherwise configured to, individually or collectively, perform or support such operations.

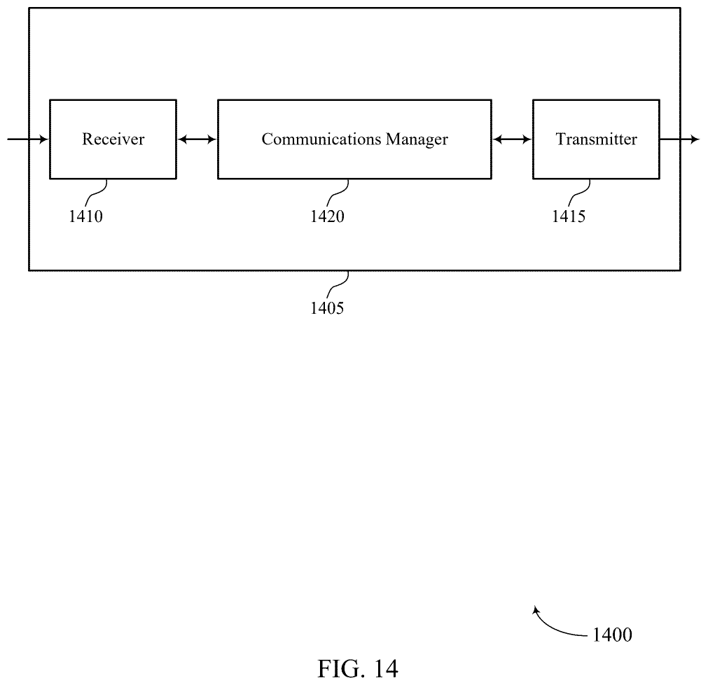

FIG. 14 shows a block diagram 1400 of a device 1405 that supports SBFD configuration in carrier aggregation in accordance with one or more aspects of the present disclosure. The device 1405 may be an example of aspects of a UE 115 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to, individually or collectively, support or enable the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to SBFD configuration in carrier aggregation). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to SBFD configuration in carrier aggregation). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations or components thereof may be examples of means for performing various aspects of SBFD configuration in carrier aggregation as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor (e.g., referred to as a processor-executable code). If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. For example, the communications manager 1420 is capable of, configured to, or operable to support a means for receiving a carrier aggregation configuration that supports a first CC associated with a primary cell and a second CC associated with a secondary cell. The communications manager 1420 is capable of, configured to, or operable to support a means for receiving a SBFD configuration, the SBFD configuration including an SBFD pattern across the first CC and the second CC. The communications manager 1420 is capable of, configured to, or operable to support a means for receiving a configuration for a cross link interference measurement in a first CC. The communications manager 1420 is capable of, configured to, or operable to support a means for receiving an indication of a deactivation of the secondary cell. The communications manager 1420 is capable of, configured to, or operable to support a means for determining whether to suspend the cross link interference measurement based on the SBFD pattern and the deactivation of the secondary cell.

Additionally, or alternatively, the communications manager 1420 may support wireless communication in accordance with examples as disclosed herein. For example, the communications manager 1420 is capable of, configured to, or operable to support a means for receiving a carrier aggregation configuration that supports a first CC and a second CC. The communications manager 1420 is capable of, configured to, or operable to support a means for receiving a SBFD pattern across the first CC and the second CC. The communications manager 1420 is capable of, configured to, or operable to support a means for performing collision handling between a first grant in an uplink sub-band of the SBFD pattern and a second grant in a downlink sub-band of the SBFD pattern, where the uplink sub-band and the downlink sub-band are configured in one or more symbols.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for more efficient utilization of communication resources.

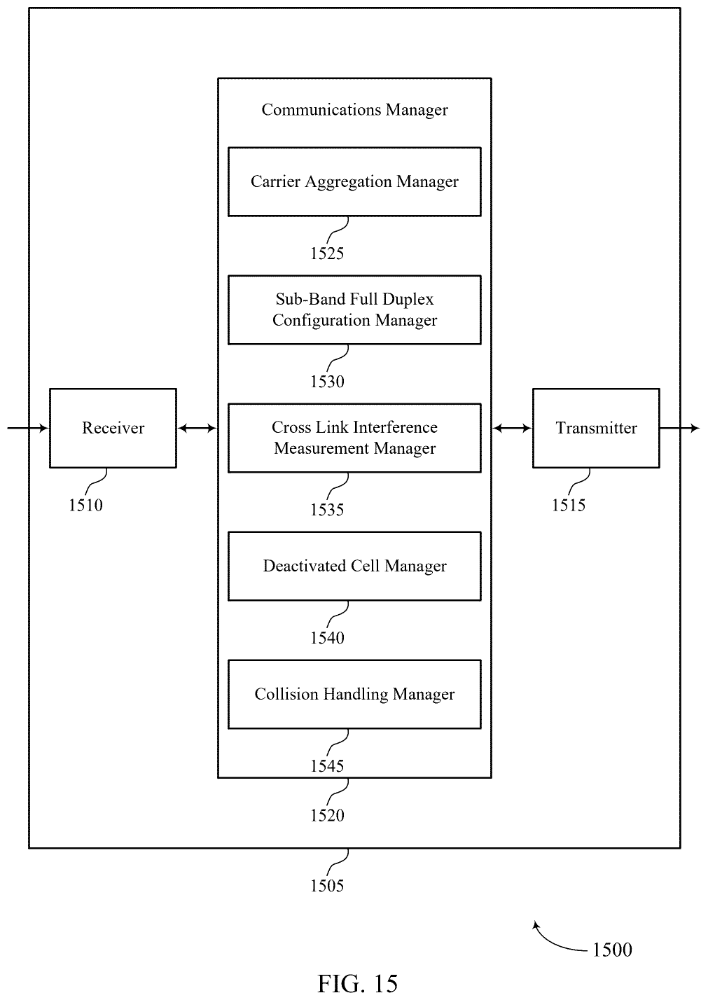

FIG. 15 shows a block diagram 1500 of a device 1505 that supports SBFD configuration in carrier aggregation in accordance with one or more aspects of the present disclosure. The device 1505 may be an example of aspects of a device 1405 or a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to support the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to SBFD configuration in carrier aggregation). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to SBFD configuration in carrier aggregation). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of SBFD configuration in carrier aggregation as described herein. For example, the communications manager 1520 may include a carrier aggregation manager 1525, a SBFD configuration manager 1530, a cross link interference measurement manager 1535, a deactivated cell manager 1540, a collision handling manager 1545, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication in accordance with examples as disclosed herein. The carrier aggregation manager 1525 is capable of, configured to, or operable to support a means for receiving a carrier aggregation configuration that supports a first CC associated with a primary cell and a second CC associated with a secondary cell. The SBFD configuration manager 1530 is capable of, configured to, or operable to support a means for receiving a SBFD configuration, the SBFD configuration including an SBFD pattern across the first CC and the second CC. The cross link interference measurement manager 1535 is capable of, configured to, or operable to support a means for receiving a configuration for a cross link interference measurement in a first CC. The deactivated cell manager 1540 is capable of, configured to, or operable to support a means for receiving an indication of a deactivation of the secondary cell. The cross link interference measurement manager 1535 is capable of, configured to, or operable to support a means for determining whether to suspend the cross link interference measurement based on the SBFD pattern and the deactivation of the secondary cell.

Additionally, or alternatively, the communications manager 1520 may support wireless communication in accordance with examples as disclosed herein. The carrier aggregation manager 1525 is capable of, configured to, or operable to support a means for receiving a carrier aggregation configuration that supports a first CC and a second CC. The SBFD configuration manager 1530 is capable of, configured to, or operable to support a means for receiving a SBFD pattern across the first CC and the second CC. The collision handling manager 1545 is capable of, configured to, or operable to support a means for performing collision handling between a first grant in an uplink sub-band of the SBFD pattern and a second grant in a downlink sub-band of the SBFD pattern, where the uplink sub-band and the downlink sub-band are configured in one or more symbols.

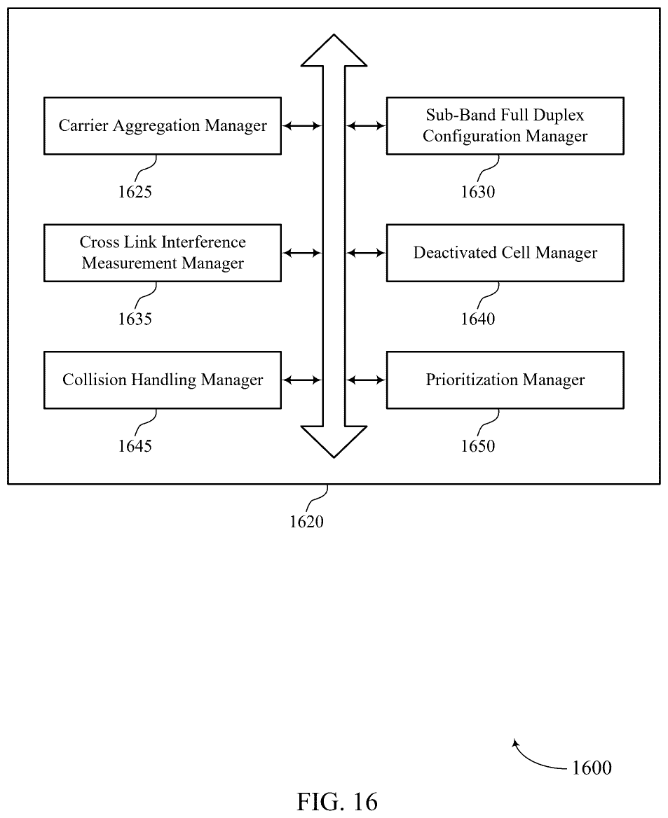

FIG. 16 shows a block diagram 1600 of a communications manager 1620 that supports SBFD configuration in carrier aggregation in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of SBFD configuration in carrier aggregation as described herein. For example, the communications manager 1620 may include a carrier aggregation manager 1625, a SBFD configuration manager 1630, a cross link interference measurement manager 1635, a deactivated cell manager 1640, a collision handling manager 1645, a prioritization manager 1650, or any combination thereof. Each of these components, or components or subcomponents thereof (e.g., one or more processors, one or more memories), may communicate, directly or indirectly, with one another (e.g., via one or more buses).

The communications manager 1620 may support wireless communication in accordance with examples as disclosed herein. The carrier aggregation manager 1625 is capable of, configured to, or operable to support a means for receiving a carrier aggregation configuration that supports a first CC associated with a primary cell and a second CC associated with a secondary cell. The SBFD configuration manager 1630 is capable of, configured to, or operable to support a means for receiving a SBFD configuration, the SBFD configuration including an SBFD pattern across the first CC and the second CC. The cross link interference measurement manager 1635 is capable of, configured to, or operable to support a means for receiving a configuration for a cross link interference measurement in a first CC. The deactivated cell manager 1640 is capable of, configured to, or operable to support a means for receiving an indication of a deactivation of the secondary cell. In some examples, the cross link interference measurement manager 1635 is capable of, configured to, or operable to support a means for determining whether to suspend the cross link interference measurement based on the SBFD pattern and the deactivation of the secondary cell.

In some examples, to support determining whether to suspend the cross link interference measurement, the cross link interference measurement manager 1635 is capable of, configured to, or operable to support a means for determining to perform the cross link interference measurement based on the SBFD pattern including an uplink sub-band in the first CC for the cross link interference measurement.

In some examples, the cross link interference measurement manager 1635 is capable of, configured to, or operable to support a means for performing, subsequent to determining to perform the cross link interference measurement, the cross link interference measurement in the first CC.

In some examples, to support determining whether to suspend the cross link interference measurement, the cross link interference measurement manager 1635 is capable of, configured to, or operable to support a means for determining to suspend the cross link interference measurement based on the SBFD pattern not including an uplink sub-band in the first CC for the cross link interference measurement.

Additionally, or alternatively, the communications manager 1620 may support wireless communication in accordance with examples as disclosed herein. In some examples, the carrier aggregation manager 1625 is capable of, configured to, or operable to support a means for receiving a carrier aggregation configuration that supports a first CC and a second CC. In some examples, the SBFD configuration manager 1630 is capable of, configured to, or operable to support a means for receiving a SBFD pattern across the first CC and the second CC. The collision handling manager 1645 is capable of, configured to, or operable to support a means for performing collision handling between a first grant in an uplink sub-band of the SBFD pattern and a second grant in a downlink sub-band of the SBFD pattern, where the uplink sub-band and the downlink sub-band are configured in one or more symbols.

In some examples, uplink sub-band and the downlink sub-band are in the first CC.

In some examples, uplink sub-band is in the first CC and the downlink sub-band is in the second CC.

In some examples, to support performing collision handling, the prioritization manager 1650 is capable of, configured to, or operable to support a means for prioritizing dynamic scheduling in the uplink sub-band or the downlink sub-band over semi-static scheduling in the uplink sub-band or the downlink sub-band.

In some examples, to support performing collision handling, the prioritization manager 1650 is capable of, configured to, or operable to support a means for prioritizing the uplink sub-band.

In some examples, to support performing collision handling, the prioritization manager 1650 is capable of, configured to, or operable to support a means for prioritizing the downlink sub-band.

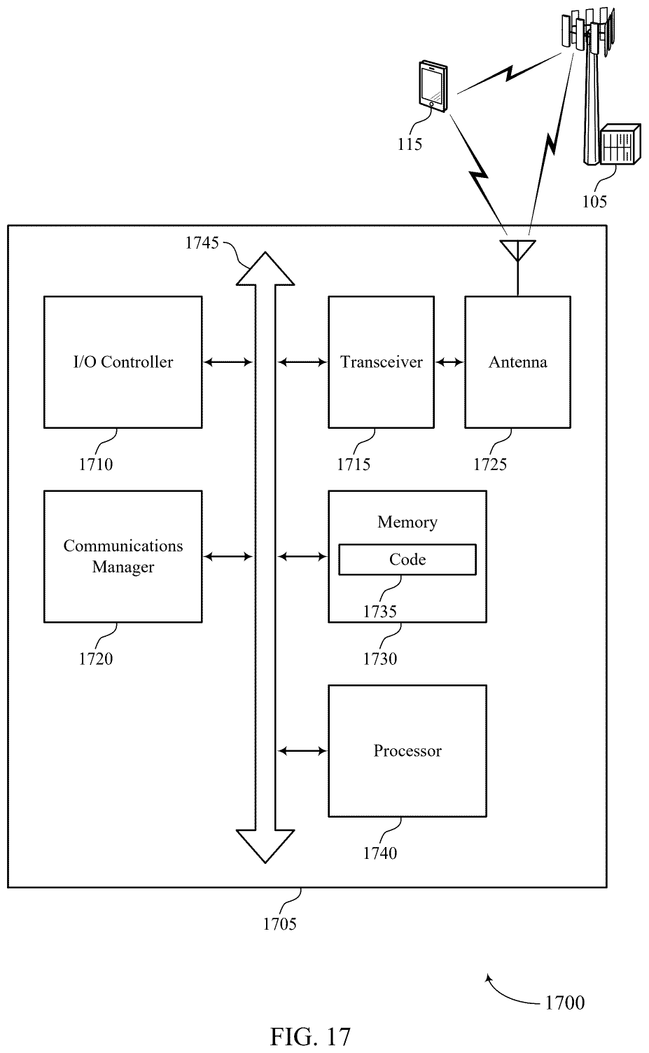

FIG. 17 shows a diagram of a system 1700 including a device 1705 that supports SBFD configuration in carrier aggregation in accordance with one or more aspects of the present disclosure. The device 1705 may be an example of or include components of a device 1405, a device 1505, or a UE 115 as described herein. The device 1705 may communicate (e.g., wirelessly) with one or more other devices (e.g., network entities 105, UEs 115, or a combination thereof). The device 1705 may include components for bi-directional voice and data communications including components for transmitting and receiving communications, such as a communications manager 1720, an input/output (I/O) controller, such as an I/O controller 1710, a transceiver 1715, one or more antennas 1725, at least one memory 1730, code 1735, and at least one processor 1740. These components may be in electronic communication or otherwise coupled (e.g., operatively, communicatively, functionally, electronically, electrically) via one or more buses (e.g., a bus 1745).

The I/O controller 1710 may manage input and output signals for the device 1705. The I/O controller 1710 may also manage peripherals not integrated into the device 1705. In some cases, the I/O controller 1710 may represent a physical connection or port to an external peripheral. In some cases, the I/O controller 1710 may utilize an operating system such as iOS®, ANDROID®, MS-DOS®, MS-WINDOWS®, OS/2®, UNIX®, LINUX®, or another known operating system. Additionally, or alternatively, the I/O controller 1710 may represent or interact with a modem, a keyboard, a mouse, a touchscreen, or a similar device. In some cases, the I/O controller 1710 may be implemented as part of one or more processors, such as the at least one processor 1740. In some cases, a user may interact with the device 1705 via the I/O controller 1710 or via hardware components controlled by the I/O controller 1710.

In some cases, the device 1705 may include a single antenna. However, in some other cases, the device 1705 may have more than one antenna, which may be capable of concurrently transmitting or receiving multiple wireless transmissions. The transceiver 1715 may communicate bi-directionally via the one or more antennas 1725 using wired or wireless links as described herein. For example, the transceiver 1715 may represent a wireless transceiver and may communicate bi-directionally with another wireless transceiver. The transceiver 1715 may also include a modem to modulate the packets, to provide the modulated packets to one or more antennas 1725 for transmission, and to demodulate packets received from the one or more antennas 1725. The transceiver 1715, or the transceiver 1715 and one or more antennas 1725, may be an example of a transmitter 1415, a transmitter 1515, a receiver 1410, a receiver 1510, or any combination thereof or component thereof, as described herein.

The at least one memory 1730 may include random access memory (RAM) and read-only memory (ROM). The at least one memory 1730 may store computer-readable, computer-executable, or processor-executable code, such as the code 1735. The code 1735 may include instructions that, when executed by the at least one processor 1740, cause the device 1705 to perform various functions described herein. The code 1735 may be stored in a non-transitory computer-readable medium such as system memory or another type of memory. In some cases, the code 1735 may not be directly executable by the at least one processor 1740 but may cause a computer (e.g., when compiled and executed) to perform functions described herein. In some cases, the at least one memory 1730 may include, among other things, a basic I/O system (BIOS) which may control basic hardware or software operation such as the interaction with peripheral components or devices.

The at least one processor 1740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1740 may be configured to operate a memory array using a memory controller. In some other cases, a memory controller may be integrated into the at least one processor 1740. The at least one processor 1740 may be configured to execute computer-readable instructions stored in a memory (e.g., the at least one memory 1730) to cause the device 1705 to perform various functions (e.g., functions or tasks supporting SBFD configuration in carrier aggregation). For example, the device 1705 or a component of the device 1705 may include at least one processor 1740 and at least one memory 1730 coupled with or to the at least one processor 1740, the at least one processor 1740 and the at least one memory 1730 configured to perform various functions described herein.

In some examples, the at least one processor 1740 may include multiple processors and the at least one memory 1730 may include multiple memories. One or more of the multiple processors may be coupled with one or more of the multiple memories, which may, individually or collectively, be configured to perform various functions described herein. In some examples, the at least one processor 1740 may be a component of a processing system, which may refer to a system (such as a series) of machines, circuitry (including, for example, one or both of processor circuitry (which may include the at least one processor 1740) and memory circuitry (which may include the at least one memory 1730)), or components, that receives or obtains inputs and processes the inputs to produce, generate, or obtain a set of outputs. The processing system may be configured to perform one or more of the functions described herein. For example, the at least one processor 1740 or a processing system including the at least one processor 1740 may be configured to, configurable to, or operable to cause the device 1705 to perform one or more of the functions described herein. Further, as described herein, being “configured to,” being “configurable to,” and being “operable to” may be used interchangeably and may be associated with a capability, when executing code 1735 (e.g., processor-executable code) stored in the at least one memory 1730 or otherwise, to perform one or more of the functions described herein.

The communications manager 1720 may support wireless communication in accordance with examples as disclosed herein. For example, the communications manager 1720 is capable of, configured to, or operable to support a means for receiving a carrier aggregation configuration that supports a first CC associated with a primary cell and a second CC associated with a secondary cell. The communications manager 1720 is capable of, configured to, or operable to support a means for receiving a SBFD configuration, the SBFD configuration including an SBFD pattern across the first CC and the second CC. The communications manager 1720 is capable of, configured to, or operable to support a means for receiving a configuration for a cross link interference measurement in a first CC. The communications manager 1720 is capable of, configured to, or operable to support a means for receiving an indication of a deactivation of the secondary cell. The communications manager 1720 is capable of, configured to, or operable to support a means for determining whether to suspend the cross link interference measurement based on the SBFD pattern and the deactivation of the secondary cell.

Additionally, or alternatively, the communications manager 1720 may support wireless communication in accordance with examples as disclosed herein. For example, the communications manager 1720 is capable of, configured to, or operable to support a means for receiving a carrier aggregation configuration that supports a first CC and a second CC. The communications manager 1720 is capable of, configured to, or operable to support a means for receiving a SBFD pattern across the first CC and the second CC. The communications manager 1720 is capable of, configured to, or operable to support a means for performing collision handling between a first grant in an uplink sub-band of the SBFD pattern and a second grant in a downlink sub-band of the SBFD pattern, where the uplink sub-band and the downlink sub-band are configured in one or more symbols.

By including or configuring the communications manager 1720 in accordance with examples as described herein, the device 1705 may support techniques for reduced latency, more efficient utilization of communication resources, and improved coordination between devices.

In some examples, the communications manager 1720 may be configured to perform various operations (e.g., receiving, monitoring, transmitting) using or otherwise in cooperation with the transceiver 1715, the one or more antennas 1725, or any combination thereof. Although the communications manager 1720 is illustrated as a separate component, in some examples, one or more functions described with reference to the communications manager 1720 may be supported by or performed by the at least one processor 1740, the at least one memory 1730, the code 1735, or any combination thereof. For example, the code 1735 may include instructions executable by the at least one processor 1740 to cause the device 1705 to perform various aspects of SBFD configuration in carrier aggregation as described herein, or the at least one processor 1740 and the at least one memory 1730 may be otherwise configured to, individually or collectively, perform or support such operations.

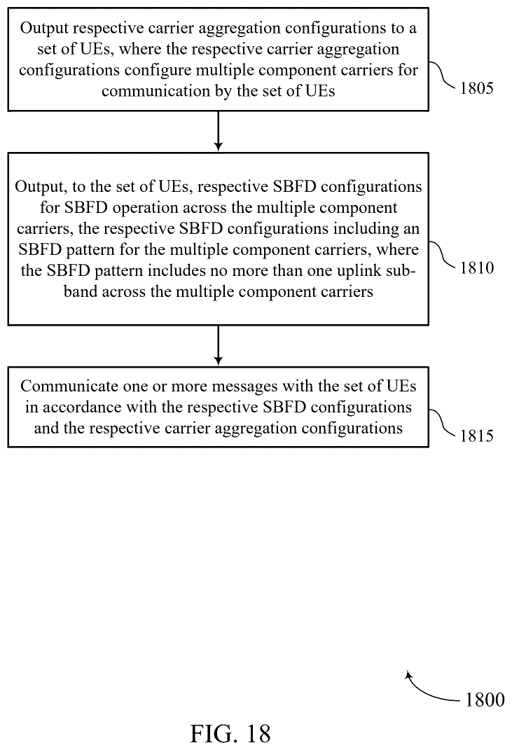

FIG. 18 shows a flowchart illustrating a method 1800 that supports SBFD configuration in carrier aggregation in accordance with one or more aspects of the present disclosure. The operations of the method 1800 may be implemented by a network entity or its components as described herein. For example, the operations of the method 1800 may be performed by a network entity as described with reference to FIGS. 1 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting respective carrier aggregation configurations to a set of UEs, where the respective carrier aggregation configurations configure multiple CCs for communication by the set of UEs. The operations of 1805 may be performed in accordance with examples as disclosed herein. In some examples, aspects of the operations of 1805 may be performed by a carrier aggregation manager 1225 as described with reference to FIG. 12.

At 1810, the method may include outputting, to the set of UEs, respective SBFD configurations for SBFD operation across the multiple CCs, the respective SBFD configurations including an SBFD pattern for the multiple CCs, where the SBFD pattern includes no more than one uplink sub-band across the multiple CCs. The operations of 1810 may be performed in accordance with examples as disclosed herein. In some examples, aspects of the operations of 1810 may be performed by a SBFD configuration manager 1230 as described with reference to FIG. 12.

At 1815, the method may include communicating one or more messages with the set of UEs in accordance with the respective SBFD configurations and the respective carrier aggregation configurations. The operations of 1815 may be performed in accordance with examples as disclosed herein. In some examples, aspects of the operations of 1815 may be performed by a message manager 1235 as described with reference to FIG. 12.

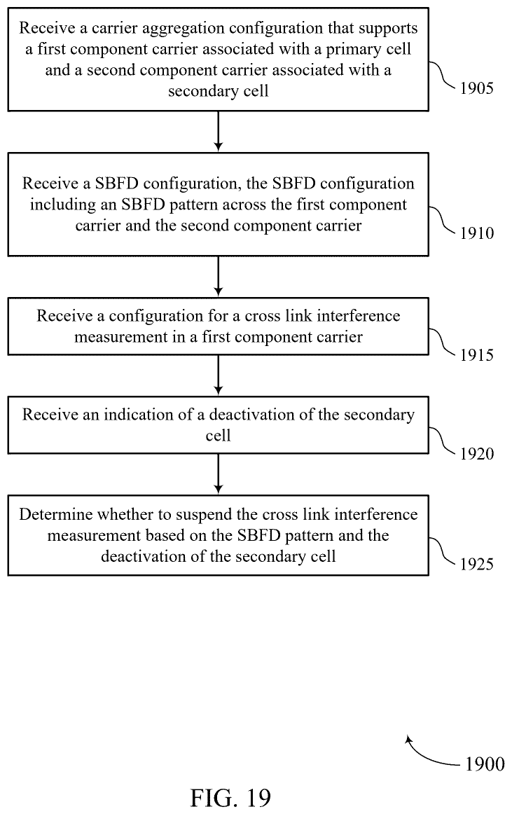

FIG. 19 shows a flowchart illustrating a method 1900 that supports SBFD configuration in carrier aggregation in accordance with one or more aspects of the present disclosure. The operations of the method 1900 may be implemented by a UE or its components as described herein. For example, the operations of the method 1900 may be performed by a UE 115 as described with reference to FIGS. 1 through 9 and 14 through 17. In some examples, a UE may execute a set of instructions to control the functional elements of the UE to perform the described functions. Additionally, or alternatively, the UE may perform aspects of the described functions using special-purpose hardware.

At 1905, the method may include receiving a carrier aggregation configuration that supports a first CC associated with a primary cell and a second CC associated with a secondary cell. The operations of 1905 may be performed in accordance with examples as disclosed herein. In some examples, aspects of the operations of 1905 may be performed by a carrier aggregation manager 1625 as described with reference to FIG. 16.

At 1910, the method may include receiving a SBFD configuration, the SBFD configuration including an SBFD pattern across the first CC and the second CC. The operations of 1910 may be performed in accordance with examples as disclosed herein. In some examples, aspects of the operations of 1910 may be performed by a SBFD configuration manager 1630 as described with reference to FIG. 16.

At 1915, the method may include receiving a configuration for a cross link interference measurement in a first CC. The operations of 1915 may be performed in accordance with examples as disclosed herein. In some examples, aspects of the operations of 1915 may be performed by a cross link interference measurement manager 1635 as described with reference to FIG. 16.

At 1920, the method may include receiving an indication of a deactivation of the secondary cell. The operations of 1920 may be performed in accordance with examples as disclosed herein. In some examples, aspects of the operations of 1920 may be performed by a deactivated cell manager 1640 as described with reference to FIG. 16.

At 1925, the method may include determining whether to suspend the cross link interference measurement based on the SBFD pattern and the deactivation of the secondary cell. The operations of 1925 may be performed in accordance with examples as disclosed herein. In some examples, aspects of the operations of 1925 may be performed by a cross link interference measurement manager 1635 as described with reference to FIG. 16.

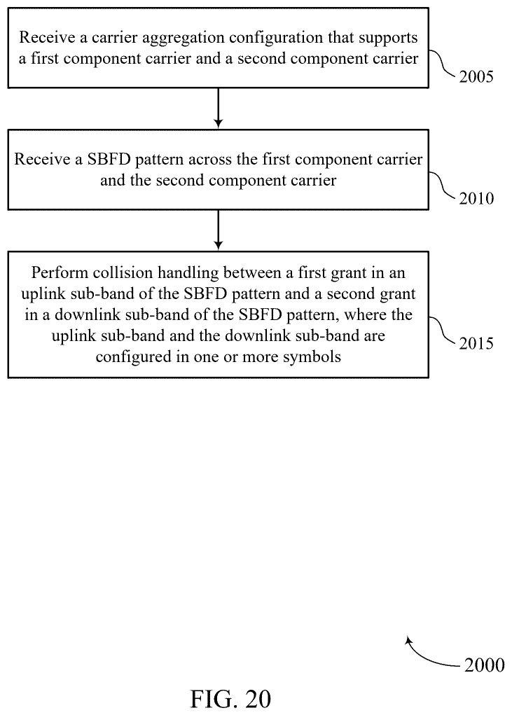

FIG. 20 shows a flowchart illustrating a method 2000 that supports SBFD configuration in carrier aggregation in accordance with one or more aspects of the present disclosure. The operations of the method 2000 may be implemented by a UE or its components as described herein. For example, the operations of the method 2000 may be performed by a UE 115 as described with reference to FIGS. 1 through 9 and 14 through 17. In some examples, a UE may execute a set of instructions to control the functional elements of the UE to perform the described functions. Additionally, or alternatively, the UE may perform aspects of the described functions using special-purpose hardware.

At 2005, the method may include receiving a carrier aggregation configuration that supports a first CC and a second CC. The operations of 2005 may be performed in accordance with examples as disclosed herein. In some examples, aspects of the operations of 2005 may be performed by a carrier aggregation manager 1625 as described with reference to FIG. 16.

At 2010, the method may include receiving a SBFD pattern across the first CC and the second CC. The operations of 2010 may be performed in accordance with examples as disclosed herein. In some examples, aspects of the operations of 2010 may be performed by a SBFD configuration manager 1630 as described with reference to FIG. 16.

At 2015, the method may include performing collision handling between a first grant in an uplink sub-band of the SBFD pattern and a second grant in a downlink sub-band of the SBFD pattern, where the uplink sub-band and the downlink sub-band are configured in one or more symbols. The operations of 2015 may be performed in accordance with examples as disclosed herein. In some examples, aspects of the operations of 2015 may be performed by a collision handling manager 1645 as described with reference to FIG. 16.

The following provides an overview of aspects of the present disclosure:

Aspect 1: A method for wireless communication by a network entity, comprising: outputting respective carrier aggregation configurations to a set of user equipments (UEs), wherein the respective carrier aggregation configurations configure multiple CCs for communication by the set of UEs; outputting, to the set of UEs, respective SBFD configurations for SBFD operation across the multiple CCs, the respective SBFD configurations comprising an SBFD pattern for the multiple CCs, wherein the SBFD pattern comprises no more than one uplink sub-band across the multiple CCs; and communicating one or more messages with the set of UEs in accordance with the respective SBFD configurations and the respective carrier aggregation configurations.

Aspect 2: The method of aspect 1, wherein the no more than one uplink sub-band is configured within a single CC of the multiple CCs.

Aspect 3: The method of aspect 1, wherein the no more than one uplink sub-band is configured across more than one contiguous CCs of the multiple CCs.

Aspect 4: The method of aspect 1, wherein the no more than one uplink sub-band occupies an entire bandwidth of one of the multiple CCs.

Aspect 5: The method of aspect 1, wherein the SBFD pattern comprises one or more downlink sub-bands configured across the multiple CCs.

Aspect 6: The method of aspects 1, wherein the SBFD pattern comprises no more than two downlink sub-bands configured across the multiple CCs, the multiple CCs are contiguous.

Aspect 7: The method of aspect 1, wherein the multiple CCs comprise a first quantity of non-contiguous frequency blocks, the SBFD pattern comprises a second quantity of downlink sub-bands configured across the multiple CCs, the second quantity is one greater than the first quantity.

Aspect 8: The method of aspect 1, wherein the SBFD pattern comprises a downlink sub-band that spans at least two CCs of the multiple CCs, the at least two CCs are contiguous.

Aspect 9: The method of aspect 1, wherein the multiple CCs are contiguous.

Aspect 10: The method of aspect 1 through 9, wherein at least two CCs of the multiple CCs are non-contiguous with each other.

Aspect 11: The method of aspect 1, wherein the multiple CCs comprise a first subset of CCs and a second subset of CCs, the first subset of CCs is associated with a first SFBD pattern and the second subset of CCs is associated with a second SFBD pattern, the first SFBD pattern and the second SFBD pattern have a non-aligned time configuration, the non-aligned time configuration is based at least in part on capabilities of the set of UEs.

Aspect 12: A method for wireless communication by a UE, comprising: receiving a carrier aggregation configuration that supports a first CC associated with a primary cell and a second CC associated with a secondary cell; receiving a SBFD configuration, the SBFD configuration comprising an SBFD pattern across the first CC and the second CC; receiving a configuration for a cross link interference measurement in a first CC; receiving an indication of a deactivation of the secondary cell; and determining whether to suspend the cross link interference measurement based at least in part on the SBFD pattern and the deactivation of the secondary cell.

Aspect 13: The method of aspect 12, wherein determining whether to suspend the cross link interference measurement further comprises: determining to perform the cross link interference measurement based on the SBFD pattern comprising an uplink sub-band in the first CC for the cross link interference measurement.

Aspect 14: The method of aspect 13, further comprising: performing, subsequent to determining to perform the cross link interference measurement, the cross link interference measurement in the first CC.

Aspect 15: The method of any of aspect 12, wherein determining whether to suspend the cross link interference measurement further comprises: determining to suspend the cross link interference measurement based on the SBFD pattern not comprising an uplink sub-band in the first CC for the cross link interference measurement.

Aspect 16: A method for wireless communication by a UE, comprising: receiving a carrier aggregation configuration that supports a first CC and a second CC; receiving a SBFD pattern across the first CC and the second CC; and performing collision handling between a first grant in an uplink sub-band of the SBFD pattern and a second grant in a downlink sub-band of the SBFD pattern, wherein the uplink sub-band and the downlink sub-band are configured in one or more symbols.

Aspect 17: The method of aspect 16, wherein uplink sub-band and the downlink sub-band are in the first CC.

Aspect 18: The method of aspect 16, wherein uplink sub-band is in the first CC and the downlink sub-band is in the second CC.

Aspect 19: The method of aspect 16, wherein performing collision handling further comprises: prioritizing dynamic scheduling in the uplink sub-band or the downlink sub-band over semi-static scheduling in the uplink sub-band or the downlink sub-band.

Aspect 20: The method of aspect 16, wherein performing collision handling further comprises: prioritizing the uplink sub-band.

Aspect 21: The method of aspect 16, wherein performing collision handling further comprises: prioritizing the downlink sub-band.

Aspect 22: A network entity for wireless communication, comprising one or more memories storing processor-executable code, and one or more processors coupled with the one or more memories and individually or collectively operable to execute the code to cause the network entity to perform a method of any of aspects 1 through 11.

Aspect 23: A network entity for wireless communication, comprising at least one means for performing a method of any of aspects 1 through 11.

Aspect 24: A non-transitory computer-readable medium storing code for wireless communication, the code comprising instructions executable by one or more processors to perform a method of any of aspects 1 through 11.

Aspect 25: A UE for wireless communication, comprising one or more memories storing processor-executable code, and one or more processors coupled with the one or more memories and individually or collectively operable to execute the code to cause the UE to perform a method of any of aspects 12 through 15.

Aspect 26: A UE for wireless communication, comprising at least one means for performing a method of any of aspects 12 through 15.

Aspect 27: A non-transitory computer-readable medium storing code for wireless communication, the code comprising instructions executable by one or more processors to perform a method of any of aspects 12 through 15.

Aspect 28: A UE for wireless communication, comprising one or more memories storing processor-executable code, and one or more processors coupled with the one or more memories and individually or collectively operable to execute the code to cause the UE to perform a method of any of aspects 16 through 21.

Aspect 29: A UE for wireless communication, comprising at least one means for performing a method of any of aspects 16 through 21.

Aspect 30: A non-transitory computer-readable medium storing code for wireless communication, the code comprising instructions executable by one or more processors to perform a method of any of aspects 16 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
output respective carrier aggregation configurations to a set of user equipments (UEs), wherein the respective carrier aggregation configurations configure multiple component carriers for communication by the set of UEs;
output, to the set of UEs, respective sub-band full duplex (SBFD) configurations for SBFD operation across the multiple component carriers, the respective SBFD configurations comprising an SBFD pattern for the multiple component carriers, wherein the SBFD pattern comprises no more than one uplink sub-band across the multiple component carriers; and
communicate one or more messages with the set of UEs in accordance with the respective SBFD configurations and the respective carrier aggregation configurations.

2. The network entity of claim 1, wherein the no more than one uplink sub-band is configured within a single component carrier of the multiple component carriers.

3. The network entity of claim 1, wherein the no more than one uplink sub-band is configured across more than one contiguous component carriers of the multiple component carriers.

4. The network entity of claim 1, wherein the no more than one uplink sub-band occupies an entire bandwidth of one of the multiple component carriers.

5. The network entity of claim 1, wherein the SBFD pattern comprises one or more downlink sub-bands configured across the multiple component carriers.

6. The network entity of claim 1, wherein:
the SBFD pattern comprises no more than two downlink sub-bands configured across the multiple component carriers, and
the multiple component carriers are contiguous.

7. The network entity of claim 1, wherein:
the multiple component carriers comprise a first quantity of non-contiguous frequency blocks,
the SBFD pattern comprises a second quantity of downlink sub-bands configured across the multiple component carriers, and
the second quantity is one greater than the first quantity.

8. The network entity of claim 1, wherein:
the SBFD pattern comprises a downlink sub-band that spans at least two component carriers of the multiple component carriers, and
the at least two component carriers are contiguous.

9. The network entity of claim 1, wherein:
the multiple component carriers are contiguous.

10. The network entity of claim 1, wherein at least two component carriers of the multiple component carriers are non-contiguous with each other.

11. The network entity of claim 1, wherein:
the multiple component carriers comprise a first subset of component carriers and a second subset of component carriers,
the first subset of component carriers is associated with a first SFBD pattern and the second subset of component carriers is associated with a second SFBD pattern,
the first SFBD pattern and the second SFBD pattern have a non-aligned time configuration, and
the non-aligned time configuration is based at least in part on capabilities of the set of UEs.

12. A UE, comprising:
one or more memories storing processor-executable code; and
one or more processors coupled with the one or more memories and individually or collectively operable to execute the code to cause the UE to:
receive a carrier aggregation configuration that supports a first component carrier associated with a primary cell and a second component carrier associated with a secondary cell;
receive a sub-band full duplex (SBFD) configuration, the SBFD configuration comprising an SBFD pattern across the first component carrier and the second component carrier;
receive a configuration for a cross link interference measurement in a first component carrier;
receive an indication of a deactivation of the secondary cell; and
determine whether to suspend the cross link interference measurement based at least in part on the SBFD pattern and the deactivation of the secondary cell.

13. The UE of claim 12, wherein, to determine whether to suspend the cross link interference measurement, the one or more processors are individually or collectively further operable to execute the code to cause the UE to:
determine to perform the cross link interference measurement based on the SBFD pattern comprising an uplink sub-band in the first component carrier for the cross link interference measurement.

14. The UE of claim 13, wherein the one or more processors are individually or collectively further operable to execute the code to cause the UE to:
perform, subsequent to determining to perform the cross link interference measurement, the cross link interference measurement in the first component carrier.

15. The UE of claim 12, wherein, to determine whether to suspend the cross link interference measurement, the one or more processors are individually or collectively further operable to execute the code to cause the UE to:
determine to suspend the cross link interference measurement based on the SBFD pattern not comprising an uplink sub-band in the first component carrier for the cross link interference measurement.

16. A UE, comprising:
one or more memories storing processor-executable code; and
one or more processors coupled with the one or more memories and individually or collectively operable to execute the code to cause the UE to:
receive a carrier aggregation configuration that supports a first component carrier and a second component carrier;
receive a sub-band full duplex (SBFD) pattern across the first component carrier and the second component carrier; and
perform collision handling between a first grant in an uplink sub-band of the SBFD pattern and a second grant in a downlink sub-band of the SBFD pattern, wherein the uplink sub-band and the downlink sub-band are configured in one or more symbols.

17. The UE of claim 16, wherein the uplink sub-band and the downlink sub-band are in the first component carrier.

18. The UE of claim 16, wherein the uplink sub-band is in the first component carrier and the downlink sub-band is in the second component carrier.

19. The UE of claim 16, wherein, to perform collision handling, the one or more processors are individually or collectively further operable to execute the code to cause the UE to:
prioritize dynamic scheduling in the uplink sub-band or the downlink sub-band over semi-static scheduling in the uplink sub-band or the downlink sub-band.

20. The UE of claim 16, wherein, to perform collision handling, the one or more processors are individually or collectively further operable to execute the code to cause the UE to:
prioritize the uplink sub-band.
